(19) United States
(12) Patent Application Publication
(10) Pub. No.: US 2008/0256445 A1
(43) Pub. Date: Oct. 16, 2008

(54) SYSTEM AND METHOD FOR AUTOMATED AIDS FOR ACTIVITIES OF DAILY LIVING

(76) Inventors: Ronald H. Olch, Lake Balboa, CA (US); Stuart Ziff, Santa Monica, CA (US)

Correspondence Address: CHRISTIE, PARKER & HALE, LLP, PO BOX 7068, PASADENA, CA, 91109-7068, US

(21) Appl. No.: 12/026,549

(22) Filed: Feb. 5, 2008

Related U.S. Application Data
(60) Provisional application No. 60/900,071, filed on Feb. 5, 2007.

(51) Int. Cl. G06F 3/00; G06F 9/00

(52) U.S. Cl. 715/700; 718/1

(57) ABSTRACT

Systems and methods for aiding individuals to complete tasks of daily living are provided. The situationally aware system comprises a controller, sensors, and effectors. The controller may include a program that describes a sequence of steps the user should perform to accomplish the task. In response to the information from the sensors and the user's compliance with the steps of the sequence, the controller instructs the effector(s) to relay at least one instructional cue to the user to aid in the performance of the task. The instructional cue may range from a simple blinking light, to detailed audio and/or visual instructions, to relaying a reward for the completion of the task. The instructional cue may also instruct the user to refrain from performing a task. The system is programmable, configurable, and may interface to the Internet.

### BACKGROUND OF THE INVENTION

The median age of the world's population is increasing because of a decline in fertility and a 20-year increase in the average life span during the second half of the 20th century. These factors, combined with elevated fertility in many countries during the two decades after World War II (i.e., the “Baby Boom”), will result in increased numbers of persons older than 65 years during 2010-2030. Worldwide, the average life span is expected to extend another 10 years by 2050. The growing number of older adults increases demands on the public health system and on medical and social services. Aging often contributes to disability, diminishes quality of life and increases health- and long-term-care costs.

For example, the United States is facing a major challenge as an aging population threatens to strain the nation's healthcare system to the breaking point. The country already feels the strain, as Congress struggles to provide prescription drug benefits for today's seniors. According to the US Census Bureau, in July 2003, 35.9 million people, or 12 percent of the total population were aged 65 and older in the United States. The cost of caring for older adults will escalate sharply in 2010, when 76 million Baby Boomers reach age 65 and begin to retire. The Alzheimer's Association, for example, reports that more than 4 million Americans have the disease—a number that is projected to more than triple to 14 million by 2050 as the elderly population continues to increase.

Activities of Daily Living (ADLs) are routine activities that people do every day without assistance. There are six basic ADLs: eating, bathing, dressing, toileting, transferring (walking) and continence. Nearly half of all Americans who turn 65 during any given year will eventually enter a nursing home as a result of being unable to perform some ADLs. While the majority of those nursing-home admissions will be for less than a year, about a quarter will stay longer than a year. Typically, government coverage for nursing costs requires that an individual be unable to perform two or more of the six basic ADLs.

As defined by the American Association of Homes and Services for the Aging (AAHSA), the aging may be moved through a “continuum of care” including:
Home
Independent living apartment
Assisted living facility
Skilled nursing facility
24-hour care unit

With each successive move through this sequence, from living at home through residing in a 24-hour care facility, the cost of caring for older adults escalates and their quality of life frequently declines.

The longer an individual can live at home, that is, “aging in place,” the better their mental health and well-being. This issue is extensively addressed by organizations such as Aginginplace.org, The National Aging in Place Council, the American Society on Aging, the National Council on Aging and the AAHSA. If someone can't care for himself or herself, then others should help. This may include spouses, children, relatives, and/or hired caregivers. If this is not effective, then the person must be moved into a long-term care facility. All solutions require increasing psychological and financial costs.

In a 2005 report, the US Census Bureau reported that in 2003, 10.5 million people aged 65 or older lived alone. Another 25 million lived with a spouse, other relatives, and non-relatives. Already, about 70 to 80 percent of non-institutionalized older people receive care from friends and family, often with help from supplementary paid helpers.

Studies demonstrate that the increased use of assistive devices not only reduces “residual disability,” but also decelerates functional decline, decreases caregiver responsibilities, and reduces the hours of personal care needed. In addition, many people see such technologies as a means of maintaining their privacy. In particular, devices that help people with problems related to memory may have a significant positive improvement in the life of the aging. Such problems range from the normal effects of aging to Mild Cognitive Impairment (MCI) to effects of Alzheimer's disease and impact many aspects of daily living.

In Los Angeles, for example, a typical assisted living facility costs $2000 to $4500 a month. If an individual can remain at home, the cost of caregiving may be significantly less, by perhaps thousands of dollars per month if the need for hired caregiver hours is minimized. The funds saved by living at home may be available to purchase devices to further improve home care. These devices, in turn, might reduce the need to hire caregivers or reduce their hours. As the majority of those 65 and older do not live in assisted living facilities, there is a potentially very large and growing market for such devices.

This market for devices may be the largest for the demographic group often most responsible for care of the aging—older children taking care of one or both parents. It is important to realize that with increasingly effective medical care and healthier lifestyles, the average age of those needing care is increasing. The result is that it is not atypical to find parents over 80 years of age being assisted by children over 50. These children often have other responsibilities including their children and their own infirmities and may live some distance from the parent. These caregivers would be very receptive to any device that could simultaneously improve the care of their parent while reducing their responsibility or that of other hired help. In addition, the aging person, friends and family members involved with care giving, in various combinations, often shoulder the financial costs. Other sources of funds are private insurance, and community and government programs.

### BRIEF DESCRIPTION OF THE DRAWINGS

The above and other features and advantages of the present invention will be better understood with reference to the following detailed description when considered in conjunction with the attached drawings, in which:

FIG. 1 is a diagram of a system control hierarchy of an AA according to one embodiment of the present invention;

FIG. 2 is a diagram of a system control hierarchy of an AA according to another embodiment of the present invention;

FIG. 3 is a diagram of a system control hierarchy of an AA according to yet another embodiment of the present invention;

FIG. 4A is a schematic of a control unit configuration of an AA according to one embodiment of the present invention;

FIG. 4B is a schematic of a control unit configuration of an AA according to another embodiment of the present invention;

FIG. 4C is a schematic of a control unit configuration of an AA according to yet another embodiment of the present invention;

FIG. 5 is a diagram of a control unit of an AA according to one embodiment of the present invention;

FIG. 6 is a diagram of a sensor/effector unit according to one embodiment of the present invention;

FIG. 7 is a diagram of different implementations of an AA according to embodiments of the present invention;

FIG. 8 is a block diagram of a control unit for an AA for toothbrushing according to one embodiment of the present invention;

FIG. 9 is a block diagram of a holder for an AA for toothbrushing according to one embodiment of the present invention;

FIG. 10A is a diagram of a reminder process for an AA for toothbrushing according to one embodiment of the present invention;

FIG. 10B is a continuation of the diagram of FIG. 10A;

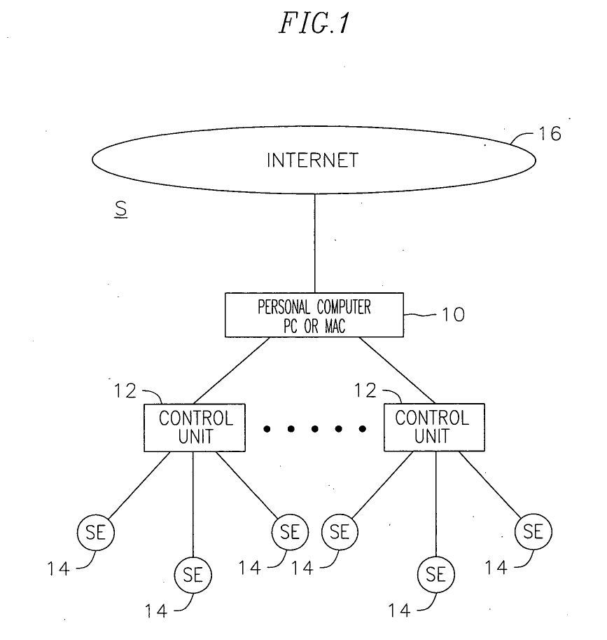

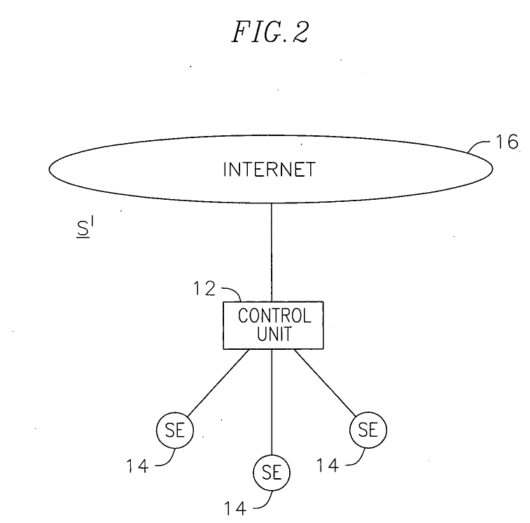

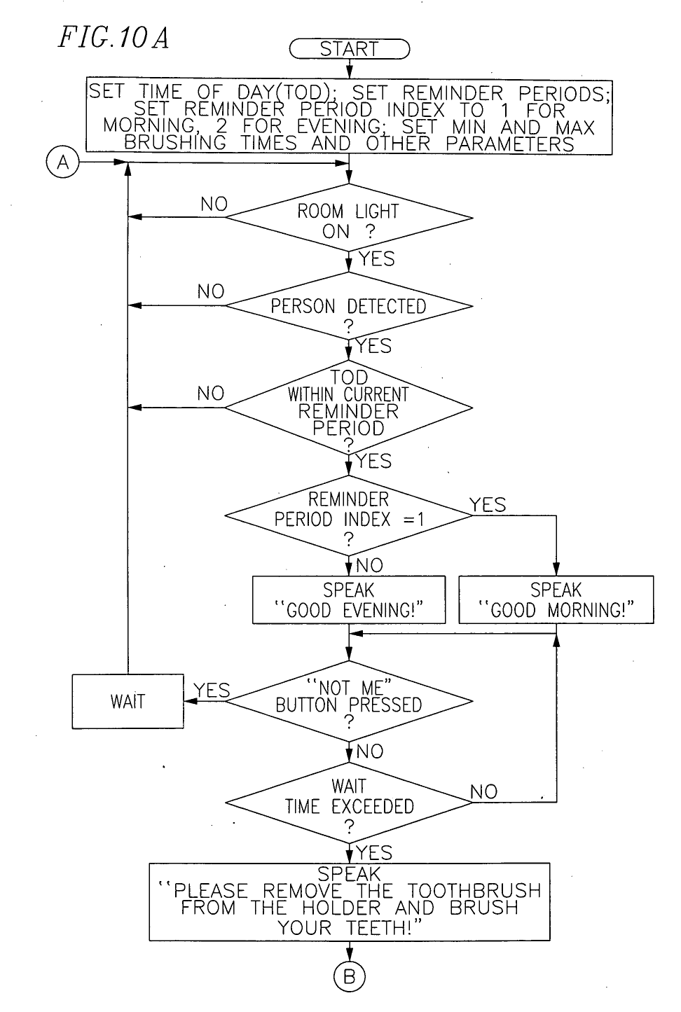

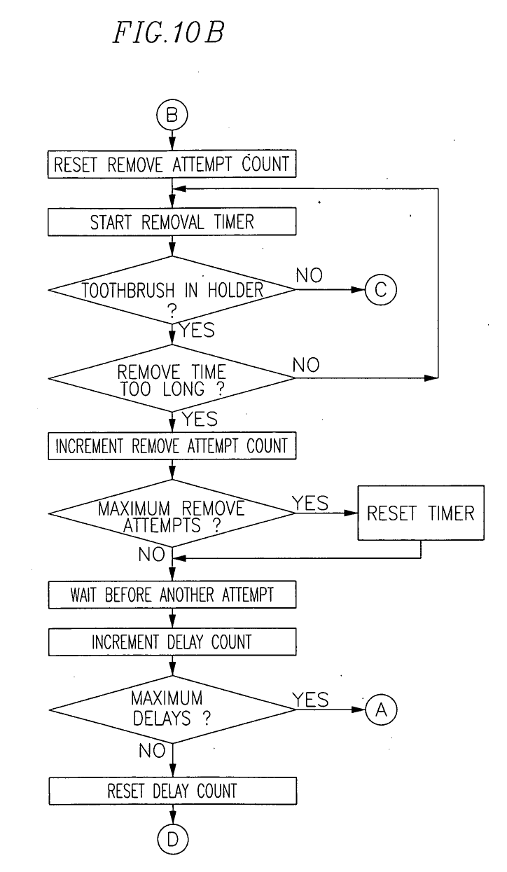

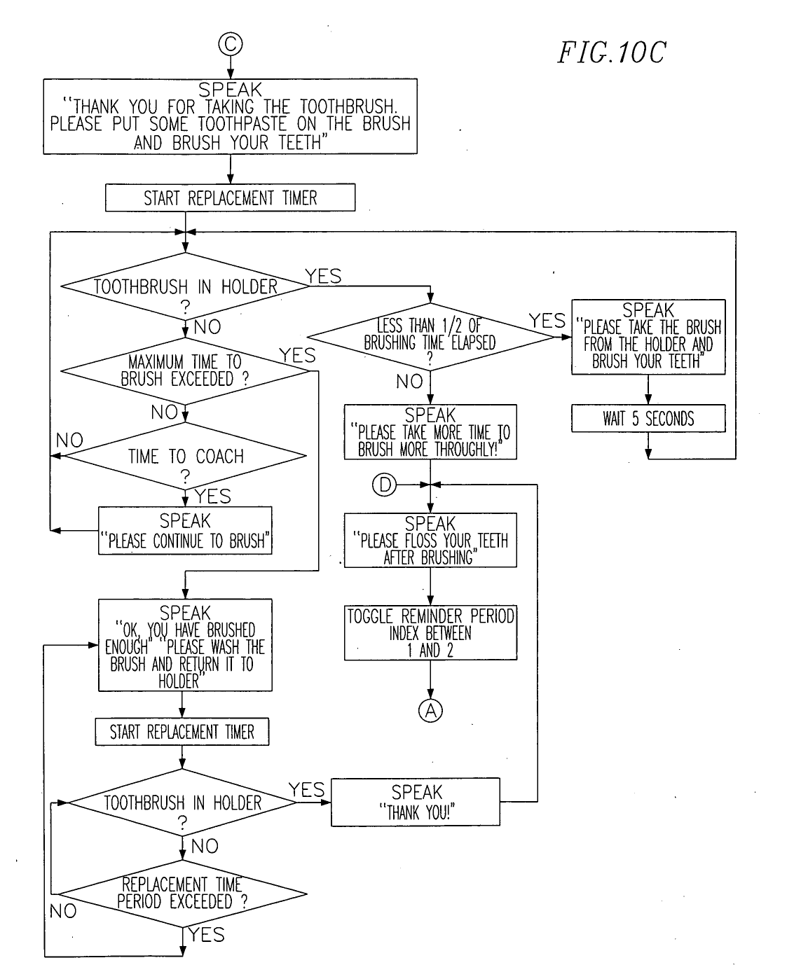

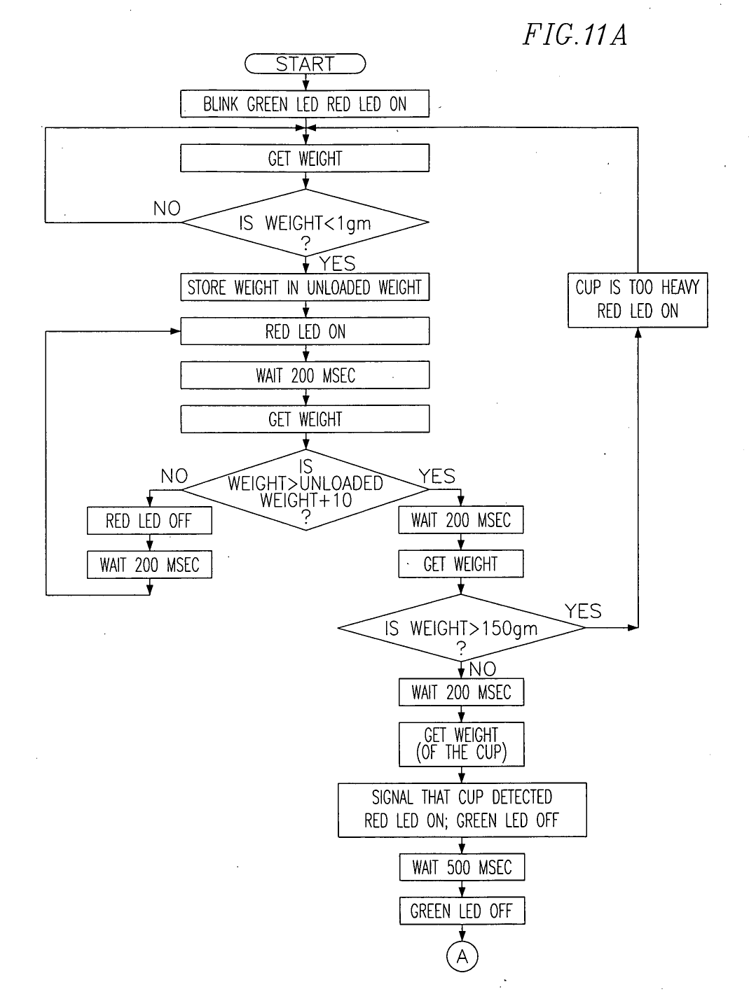

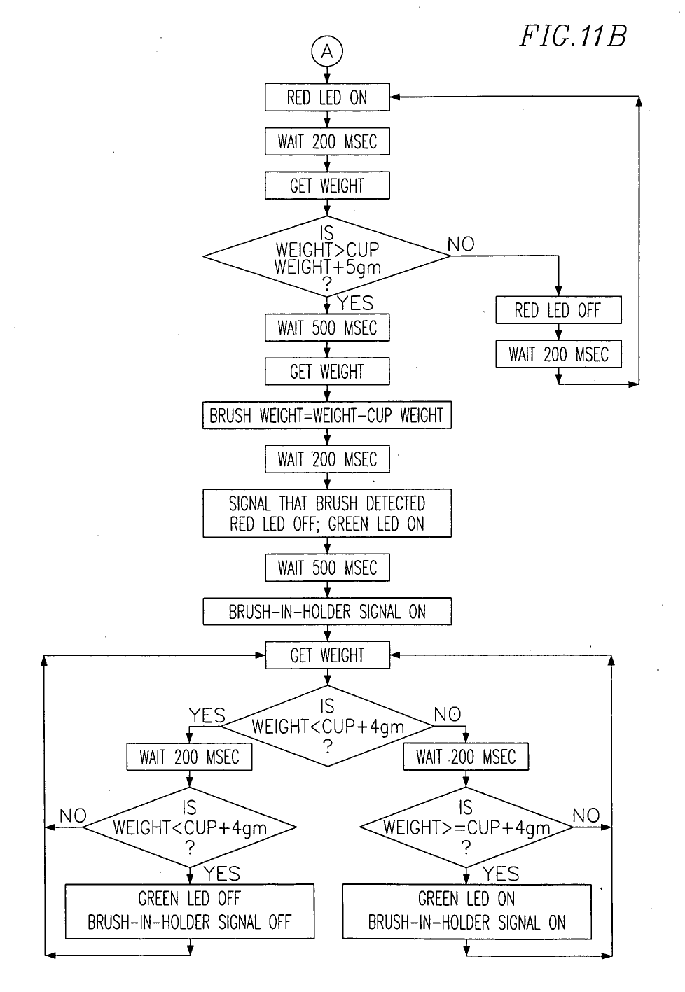

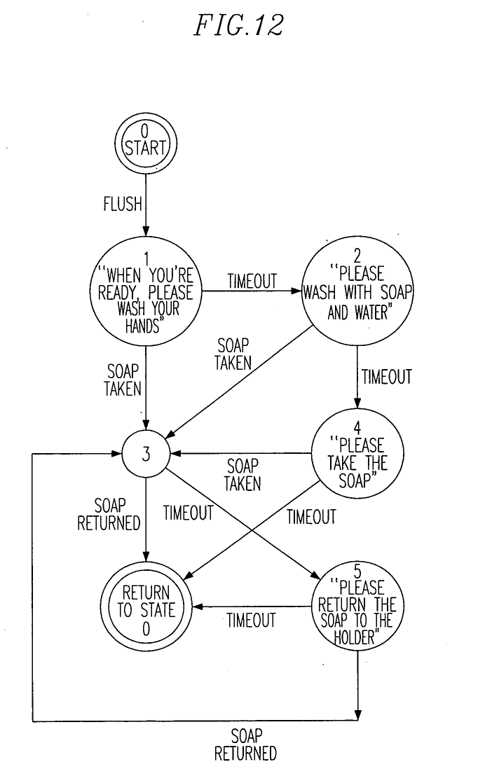

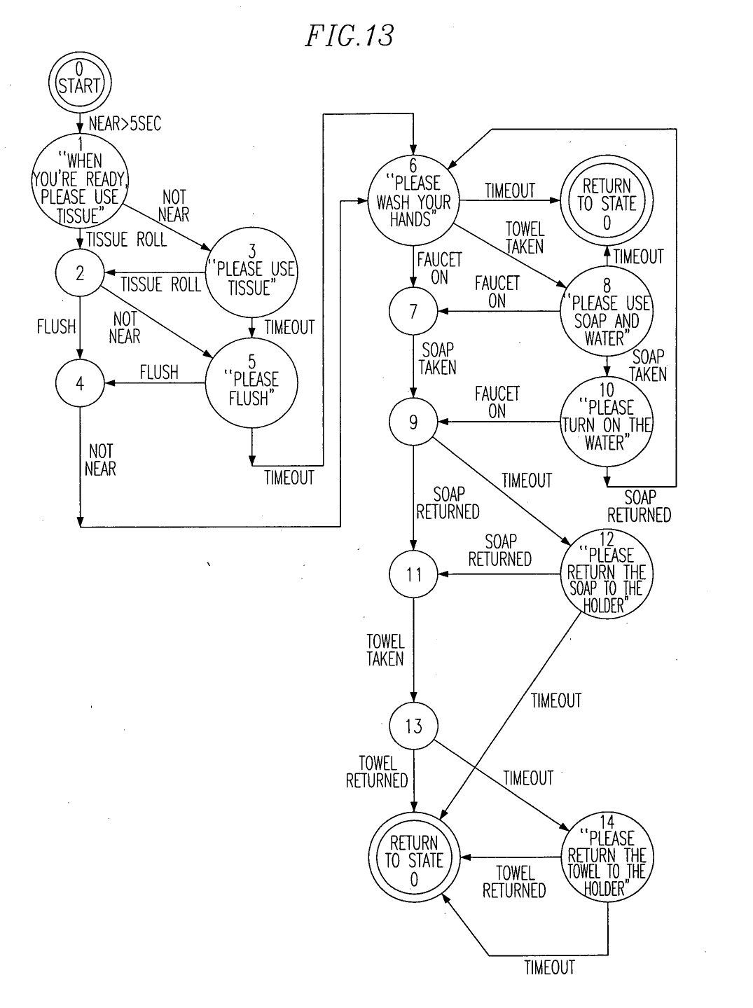

FIG. 1C is a continuation of the diagram of FIG. 10B;

FIG. 11A is a diagram of a holder detection subsystem of an AA for toothbrushing according to one embodiment of the present invention;

FIG. 11B is a continuation of the diagram of FIG. 11A;

FIG. 12 is a diagram of a process implemented by an AA for proper hygiene according to one embodiment of the present invention; and

FIG. 13 is a diagram of a process implement by an AA for proper hygiene according to another embodiment of the present invention.

### SUMMARY OF THE INVENTION

Embodiments of the present invention are directed to delivering quality care to a rapidly growing population of older adults (historically the most expensive demographic to treat) while reducing healthcare costs. In particular, embodiments of the present invention include an emphasis on prevention rather than treatment, maintaining the responsibility for care with individuals and their family and friends, and a shift in the locus of care from expensive clinical settings to the home. A range of situationally aware, intelligent, and proactive electronic devices according to embodiments of the present invention enable these goals.

Some embodiments of the invention include automated systems for aiding individuals to complete tasks of daily living. These tasks may include toothbrushing, bathing, grooming, taking medications, changing diapers, remembering to take and return personal items, and the like. In one exemplary embodiment, the system includes a computer, sensors, effectors and communication means between them. The computer executes a sequence or coaching-specific algorithm particular to the user's needs. This sequence utilizes data from the sensors to monitor actions of the user and the environment and provides situationally aware coaching prompts through the effectors to help the user perform the desired task or tasks.

Some embodiments implement user-configurable sequences on a Personal Computer (PC) and shared between user's PCs via the Internet. The sequences then run directly on the user's PC or are downloaded to a Control Unit (CU) for execution. The PC or the CU may use internal or external sensors and/or effectors.

Some embodiments use sensors and/or effectors in external Sensor/Effector Units (SEs). In some embodiments, the SEs communicate with the CU or PC by a wired interface. In other embodiments, this interface is wireless, such as the IEEE 802.15.4 radio standard. In some embodiments, the CU also communicates with the PC by wireless means.

In some embodiments, there are multiple CUs, SEs and PCs in proximity to each other. In this case, particularly when wireless means are used to connect PCs to CUs and SEs to PCs or CUs, the CUs and SEs are each uniquely identified. This unique identification enables a process that allows sequences to be downloaded to the correct CUs and for each sequence running on a processor to obtain the correct sensor data and output to the correct effectors.

### DETAILED DESCRIPTION

According to embodiments of the present invention, an Automated Aids system S for Tasks of Daily Living (hereinafter referred to as AA) includes products for guiding a user through the performance of an activity, in a correct and timely way. In one embodiment, the AA may comprise an integrated series of products for guiding the user through a number of tasks. The tasks may be any action or lack thereof and may include the use of or interaction with a particular item.

Like a caregiver, an AA appliance according to embodiments of the present invention is situationally aware. For example, it can know the proper time period in which the user should do the activity, it can detect the presence of the user and other conditions in the environment, and it can know when the user handles, uses, or otherwise interacts with an object. This situational awareness allows the AA appliance to provide appropriate instructions to guide the user through the activity in a proactive manner.

In addition to guiding a user through the performance of an activity, according to one embodiment, this situationally aware system can instruct the user not to perform a task that was previously performed. For example, if a user completes an activity of daily living, and then starts to do the activity again before the next scheduled time period, or completes an instruction out of order, the AA may communicate to the user or to the caregiver that the user already did the activity. In another embodiment, the AA might tell the user when he or she did the activity or how much time passed since doing the activity. Also, if the user starts an activity during the proper time period, but before the AA asks the person to do the activity, then the AA could thank the person for remembering to do the activity (hereinafter referred to as positive re-enforcement coaching).

Certain embodiments of an AA appliance may be adapted for individuals with impaired memory and/or impaired awareness of time and the duration between events, but is not limited thereto. “Impairment” includes the results of physical deficiencies such as dementia as well as, more broadly, results of the natural process of aging, and any other condition or malady that might affect a person's mental health and/or memory. In the context of AA assistance, impairment may also include general forgetfulness and distraction often associated with children, but that applies to all human beings. For such minor impairment, the unit can provide a simple reminder to do the activity, or not to do an activity. For severe impairment, the unit can give more detailed instructions designed to coach the user through the activity. According to some embodiments, these reminders and instructions may be provided by text displays, lighted indicators, animated objects, speech, music, sound effects, and combinations thereof.

Like a human caregiver, the unit instructs the user, rewards proper behavior, and corrects errors. “Positive reinforcement coaching” can include rewarding the user through graphic images, text, audio, or dispensing a gift or an object, for example, candy or a “gold star.” The more senses of the user the rewards involve, the more the user might experience pleasure and delight. For example, playing a jingle, displaying and image and giving a reward would have more impact than just playing a jingle.

According to embodiments of the present invention, common operational characteristics of the AA system S include Purpose, Perception, Patience and Persistence. “Purpose” refers to the system having a limited but well-defined purpose assigned to it which it tirelessly attempts to fulfill. “Perception” refers to the use of multiple internal and external sensors to maintain situational awareness and intelligently integrate sensor information. “Patience” refers to the system standing silently by until the appropriate time and conditions are met, for instance, the correct time and the proximity of the user. “Persistence” refers to the system continuing to remind until the task is performed.

In addition, according to embodiments of the present invention, the AA coaches people through tasks by giving reminders/prompts/commands that are appropriate, timely, accurate nonconfrontational and nondeprecating. “Appropriate” refers to the prompt making sense to give at the time, given the specific conditions of the moment. “Timely” refers to the prompt being given within a time frame that will make sense to the user, and not be forgotten before the user can act on the prompt. “Accurate” refers to the prompt being sufficiently explicit in the directions it gives and the objects referred to. “Nonconfrontational” refers to prompts being given in such a way that the user does not feel threatened, contradicted or confronted with making an uncomfortable decision. “Nondeprecating” refers to not pointing out the user's infirmity or chastising the user for forgetting or not complying with the instructions.

Also, according to embodiments of the invention, the AA requires minimal changes in behavior because people with disabilities often have difficulty changing their behavior and learning different ways to do things. In one embodiment, for example, the AA may use familiar items in a familiar environment and require minimal changes in the user's environment.

To be “nonconfrontational,” the AA may include music for both introduction and continuity. For example, as an introduction, music is a calm way to prepare the user for a spoken message, and may prevent startling the user. Music attracts the user's attention before the first verbal or graphic prompt. An initial verbal or graphic prompt without music may startle, scare or confuse the user, making the user less inclined to carry out the prompted actions. Music between prompts retains the user's attention in a pleasant way so that the user will be more ready and willing to follow subsequent prompts.

Some embodiments of the present invention are customizable. That is, a care giver can customize the program or sequence of events executed by the AA to have the desired characteristics (i.e., appropriate, timely, accurate, nonconfrontational, nondeprecating). The sequence includes a specification of the timing, logic, prompts, sensor inputs and effector outputs that best accomplishes the desired coaching function for the user. Sometimes, a sequence that has been effective for other users with the same disability will be sufficient. In other instances, however, such a sequence will need to be modified or its timing adjusted to be useful to the particular user. In yet other instances, an entirely new sequence will be the most effective.

In cases where the disability involves short-term memory loss, the user will often not remember previously interacting with the AA. Accordingly, repeated trials with modified sequences or parameters will not result in a negative association with the product from previous experiences. As a result, when programming an AA for such a user, it may be assumed that any previous instructions from prior days are not remembered. Therefore, coaching prompts according to one embodiment are specific and do not depend on any prior training or introduction to the AA the user may have had by a caregiver. For example, a user with mild dementia or even Alzheimer's disease may use an AA to remind her to drink. Some users will more readily comply if the AA reminds the user why it is important to complete the task (e.g., drink) each time the AA begins to prompt. This explanation may even need to be repeated at each coaching interval until the user picks up the glass and returns it.

Nonlimiting examples of functions of potential AAs include: 1) reminding a user to brush her teeth and guiding her through the process; 2) reminding and guiding a user to wash her face or brush her hair; 3) asking a user to close the refrigerator door if it was left open too long; 4) sensing temperature and user presence and reminding user to turn off oven or stove; 5) feeding and grooming pets and/or reminding user to feed and groom pets; 6) reminding the user to drink for sufficient hydration; 7) reminding the user not to leave home or finish getting dressed without using deodorant; 8) reminding the user to shave; 9) reminding a user not to forget keys, a wallet or a cell phone as a user approaches the front door; 10) reminding a user to take or return one's coat, hat, umbrella, keys, wallet or shoes as a user approaches the front door; 11) reminding the user to take medications not only based on time but also on user presence; 12) preparing the right dose of medication and coaching the user to take it correctly; 13) reminding user that it is too soon to take their medication again when the user picks up a medicine bottle before the next designated time period; 14) reminding the user to put in a dental night guard; 15) reminding a user to close the dog door to the back yard; and 16) measuring wetness of a diaper or adult diaper and notifying user that diaper needs to be changed.

According to embodiments of the invention, AAs can work with existing items commonly found in the home without requiring modification or customization. Thus, familiarity of those items is preserved and no additional cost is needed to replace them. Also, because existing objects may be used, no additional certifications are needed, (e.g. UL and approvals, and FDA). Since the items are not modified, the certifications and approvals remain in force.

The AAs according to the present invention are not simply alarms. AAs do not suffer from the same limitations as alarms. Some shortcomings of alarms are solved by the AA: 1) the AA can coach a user though the steps of an activity; 2) the AA has situational awareness, and typically does not “go off” based on only one parameter, such as time of day; 3) the AA is aware if the user is present, and is aware if the user did the intended activity; 4) the AA has more than one feedback; and 5) the AA helps an impaired user who might not remember what to do when an alarm goes off. As such, users suffering from certain impairments may not be aided by an alarm, bt would be aided by an AA.

Nonlimiting examples of classes of users that may be aided by the AAs of the present invention include: 1) older people with Mild Cognitive Impairment (MCI) or otherwise impaired concepts of time; 2) people with memory impairment caused by disease, disability, injury, stress, or medication (e.g., people with Down syndrome, autism or mild dementia); 3) young people who are forgetful or too busy to attend to needed activities; 4) anyone needing a reminder to do something with an object; and 5) anyone needing a reminder to perform an action. Table 1, below, provides a summary outline of some potential AA functions and types of users who might benefit from the use of those AAs.

TABLE 1
Applicability of Automated Aids for Tasks of Daily Living by Age and Condition

| | Recommending Specialty: | | | | | |
|---|---|---|---|---|---|---|
| | Pediatric | Ped. and Adult | | State | | Geriatric |
| | Dentistry | Orthodontist | | Services | | Dentistry |
| | Condition: | | | | | |
| | | Normal | | | | |
| | Normal | w/braces | Normal | Autistic * | Normal | Dementia |
| | Age: | | | | | |
| Machine Coaching Function | 3-12 | 12-18 | 18-40 | 12-40 | 40-65 | 65-90 |
| Toothbrushing | ✓ | ✓ | | ✓ | ✓ | ✓ |
| Putting in false teeth | | | | | ✓ | ✓ |
| Flushing toilet | ✓ | | | ✓ | ✓ | ✓ |
| Washing hands after using | ✓ | | | ✓ | | ✓ |
| toilet | | | | | | |
| Taking a bath and process | | | | ✓ | | ✓ |
| Brushing/combing hair, shaving | | | | ✓ | | ✓ |
| Using deodorant | | | | ✓ | | ✓ |
| Taking/Returning keys, wallet, | | | | ✓ | ✓ | ✓ |
| sunglasses, medication, etc | | | | | | |
| Taking water bottle/drink to hydrate | | | | ✓ | | ✓ |
| Not leaving stove burners on | | | | ✓ | ✓ | ✓ |
| Closing the refrigerator | | | | | | ✓ |
| Feeding pets | ✓ | ✓ | ✓ | ✓ | ✓ | ✓ |
| Monitoring doors to prevent | | | | ✓ | | ✓ |
| wandering | | | | | | |
| Taking pills, correct number | | ✓ | ✓ | ✓ | ✓ | ✓ |
| and time | | | | | | |
| Health monitoring and | | | ✓ | ✓ | ✓ | ✓ |
| medication adjustment | | | | | | |
| Home control assistance | | | ✓ | ✓ | ✓ | ✓ |
| effective | | | | | | |
| use of home security systems | | | | | | |
| Alerting to wet | | | | | | ✓ |
| Depends/diapers | | | | | | |
| Putting on clean clothes | | | | ✓ | | ✓ |
| Diabetic testing | ✓ | ✓ | ✓ | ✓ | ✓ | ✓ |
| Exercising | | | ✓ | ✓ | ✓ | ✓ |

* Includes Down Syndrome

As noted in Table 1, there are many potential applications for which AAs may be useful, and the AAs may be useful to a wide variety of normal and disabled users. For example, some embodiments of AAs according to the present invention may be used to improve dental hygiene, health monitoring and medication adjustment, pet care, and home control assistance.

### System Implementations

Implementations of AA devices and systems according to embodiments of the present invention may incorporate a variety of features, options and components. For example, in some embodiments, all components of a system are contained in a stand-alone, single enclosure and operate independently of each other. In other embodiments, there may be multiple subsystems that coordinate their activities with each other. In yet other embodiments, some of the sensors, such as, for example, an object sensor, are packaged in units separate from a controller. The controller integrates data from the sensors and outputs prompts to the user by means incorporated in the controller or remote from the controller. A single AA can integrate or fuse data from multiple internal and external sensors, using one or more programmed sequences, to simultaneously monitor and coach one or more users through several tasks of daily living.

Sensors are devices that respond to some stimulus, and communicate information about that stimulus. The stimulus can be any physical phenomenon, nonlimiting examples of which include heat, light, pressure, electric or magnetic fields, motion, and changes in any of these over time or space. Nonlimiting examples of suitable sensors for use in the AAs of the present invention include passive infrared (PIR) sensors, light sensors, switch sensors, heat sensors, weight sensors, accelerometer sensors, pressure sensors, resistance sensors, capacitance sensors, inductive sensors, acoustic sensors and time sensors.

Passive Infrared (PIR) sensors include solid state pyroelectric sensors that can sense the presence of a person entering a room. Light sensors include photodetectors or image sensors for detecting that a room light was turned on. Switch sensors include mechanical or electronic sensors for detecting that a door is open/closed or that keys are on a hook. Heat sensors include temperature sensors, thermometers, thermocouples, thermistors, bolometers, etc., for detecting, for example, that one or more burners on a stove have been left on. Weight sensors include strain gauges, piezoresistors, or capacitive sensors for sensing the weight of an object such as a toothbrush, soap, or water glass. Accelerometer sensors include MEMS capacitive sensors, gyros, or suspended cantilevered beams for determining the orientation of an object or a person and whether the object or person has moved. Pressure sensors include strain gauges, capacitive sensors, or other devices sensitive to changes in pressure, used, for example, to determine the height of water in a column, such as in a toilet tank. Resistance sensors include resistors for determining moisture, for example, in an adult diaper. Capacitance sensors detect the presence of a person or other object. Inductive sensors detect the presence of a metallic object. Acoustic sensors include microphones, hydrophones, etc., for listening for certain sounds, such as a dropped object or toilet flush. Time sensors include clocks for providing time of day or relative intervals. Video sensors can detect the presence of a user, the motion of a user, or recognize a unique user.

Some embodiments may use different sensors to detect the same condition. For example, a toothbrush in a holder may be detected by a switch, an optical sensor, a weight sensor, or by movement of the toothbrush as measured by an embedded accelerometer. As another example, diaper wetness may be measured by resistive or capacitive methods.

Effectors are output devices that provide feedback to the user. Nonlimiting examples of suitable effectors include audio feedback effectors, displays, strobe lights, sirens, motors and solenoids.

Audio feedback effectors can be speakers for providing voice, music and effects such as tones or chimes. Displays can include single LEDs, text and/or graphics, single and multiple colors and may use ambient light and/or back lighting. Strobe lights attract attention, particularly for users who are hard of hearing. Sirens may be used to warn the user or alert the user of an emergency. Motors and solenoids may be used for physical interaction with objects such as turning off a stove or locking a door.

Effectors may be an integral part of the controller may be or connected to the controller by wired or wireless methods. Some embodiments may use a wireless method that includes transmitting audio information where the transmission is compatible with some brands of commonly available wireless baby monitors. Other embodiments may output audio through an effector that is either local or remote from the controller. Such an effector may, in some embodiments, simply reproduce audio source played back in the controller. Other audio effector implementations may reproduce the source material stored in the effector.

The design of both Control Units (CUs) and Sensor/Effectors (SEs) allows for several mounting methods. Nonlimiting examples of these methods include freestanding on a surface, (such as a counter), or hanging on a wall. Some CUs and SEs allow for either type of mounting, leaving the choice up to the user or caregiver, who will make the decision based on the intended application and environment. For instance, wall mounting may be desired for a CU to place the display at a convenient viewing height, out of the reach of children, or protected from water or from being knocked over. Wall mounting may also be desired to prevent theft or tampering. However, a SE for a toothbrush holder, for example, may best be placed on a counter. In contrast, a SE with a PIR sensor may have a better sensing view if mounted on a wall. In some embodiments, SEs are mounted directly on or in a sensed object, such as in a toilet tank, attached to a set of keys, or on the ceiling above a stove.

Data from some sensors or to some effectors may be communicated by means of common home control standards, such as X10®, ZigBee® or Z-Wave®. In this manner, sequences implemented in Control Units (CUs) or Personal Computers (PCs) can utilize devices from many vendors for control of common appliances, such as lamps, as well as control of climate, audio, video, irrigation and security. For example, a SE may incorporate an X10® controller. In one embodiment, for example, a CU may be programmed with a sequence that integrates data from a floor mat sensor to turn on a light whenever a user gets out of bed. When the conditions for turning the light on occur (e.g., floor mat on, time between 9 PM and 8 AM) then the CU sends a message to the Sensor/Effector (SE), which sends an X10® signal to the remote X10® light controller to switch on.

Each of the applications listed above may use a unique combination of sensors and effectors. However, some sensors may be particularly useful for a variety of applications. For example, an electronic scale can be used not only to detect the presence of a toothbrush, but also to detect keys, a bar of soap, a pillbox or a night guard. The above lists are not exhaustive and other sensor and effector technologies may be usefully applied to other applications.

According to one embodiment, an AA system includes one or more sensors, one or more effectors and a programmable component that combines the sensor inputs with internal logic to drive the effectors. For example, a sensor may be a toothbrush holder that detects when a user picks up or replaces the brush, and an effector may be an audio or video reproducer that can provide verbal or graphic prompts to the user. The internal logic may include programmed sequences of sensor inputs, decisions, timing constraints and output actions. This logic can be composed by a caregiver with the particular needs of the user in mind. Alternatively, the various programmed sequences may be preinstalled, may be changeable by input devices on the AA, loaded into the AA from a PC, and/or downloaded from the internet. This can be done locally by the caregiver or remotely via the Internet. In another embodiment, the control logic is stored in a remote memory, for example, in a server that is in communication with the sensors and/or effectors through an Internet connection. Thus, interpretation of program sequences and selection of a cue to relay to the user may be done at a remote location.

Various combinations of sensors, effectors and programmable components may be incorporated into independent units. Nonlimiting examples of suitable combinations include: 1) stand-alone units with all sensors and effectors; 2) controllers with one or more sensors and one or more effectors; 3) controllers with no sensors but with effectors; 4) controllers with no effectors but with sensors; 5) controllers with no sensor or effectors (they are all remotely interfaced); 6) SEs with sensor(s) only; 7) SEs with effector(s) only; and 8) SEs with sensors and effectors.

The control system hierarchy of an AA according to embodiments of the present invention may vary depending on engineering and marketing considerations revolving around cost, size, flexibility and configurability. As illustrated in FIG. 1, one exemplary AA system control hierarchy includes the user's personal computer 10, one or more control units (CUs) 12 and one or more Sensor/Effector units (SEs) 14. The PC and CU(s) may be referred to separately or collectively as a “controller.” Alternatively, the CUs 12 or SEs 14 might be continuously connected to the Internet or local network, such that part or all of the controller function is done remotely by a server or other system for distributed computing.

The personal computer (PC or MAC) 12 may be used to configure and test control sequences. However, any computing device capable of sufficiently interacting with the user to create and store sequences and communicate with CUs or SEs could be used for this function. For example, handheld devices such as Personal Digital Assistants (PDAs) could be used. In addition, sequence information could be transferred from such a device to an AA system via a storage media such as a portable memory device or MP3 PLAYER (e.g., an iPod®).

Sequences may be created from logic elements and audio segments via a graphical user interface. Nonlimiting examples of suitable logic elements include AND, OR and NOT relationships between sensor conditions with a true result asserting one or more effector outputs. Sequences, in whole or part, may also be downloaded from the Internet. Professionals in dentistry, gerontology and others may place sequences recommended for certain types of users on their internet sites. In addition, a community of caregivers may share their insights as to what sequences or techniques used in sequences have been effective and share those sequences with others who have similar situations.

Audio segments may be recorded on the PC, either from connection to one of a variety of audio sources or from a microphone for voice recording. Tools for capturing and editing audio segments are standard on most PCs today. Music and sound effects may also be captured in this fashion, or obtained from various Internet sources subject to applicable copyright restrictions.

After a sequence is composed, it may be tested on the PC using the mouse and keyboard to simulate sensor inputs that may not be directly available. The PC's audio reproduction capability and speakers may be used to hear any audio segments that are part of the sequence.

After a sequence is composed and tested, it is downloaded into one or more CUs for execution. The CUs, interfaced to SEs for inputs and outputs, autonomously interact with the user(s) to provide the intended coaching functions.

The Internet connection shown in FIG. 1 may be accomplished by any common wired or wireless means such as via a cable modem, DSL, WiFi, ZigBee® or telephone modem. In addition to providing a source of sequences and audio segments, this interface may also be used in some embodiments for remote monitoring and control of local coaching activities. For instance, a remote caregiver may periodically view data, collected by a CU sequence, indicating the level of compliance for a particular coaching activity, such as the number of times a user actually takes a toothbrush compared to the number of attempted coaching intervals. The caregiver may use this data to confirm the efficacy of the sequence or use it to determine how the sequence should be modified to be more effective. A caregiver might also use Internet communication to remotely modify a CU sequence or adjust an operating parameter such as maximum brushing time. He could even use this capability to insert a message to be played back to the user at an appropriate sequence-driven time, such as “your next dental appointment is today at 3 PM.”

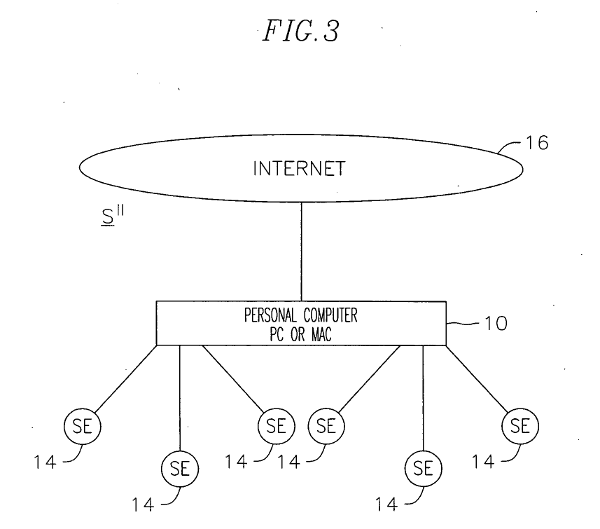

FIG. 2 illustrates another embodiment of an AA system S′ control hierarchy. In this case, sequences are downloaded to a CU 12 directly from the Internet 16 without a local PC. A location may have one or more CU/SE groups although only one is shown in FIG. 2. Each CU may have a user interface sufficient to compose or modify a sequence locally as well as to specify a sequence and source to be “pulled” from a web site. Alternatively, the CU may have only the ability to receive a sequence “pushed” into it by a remote Internet source. Regardless of the source of the sequence, the CU/SE system can have the same control and remote up/downloading capabilities as the system of FIG. 1, described above.

FIG. 3 illustrates yet another embodiment of an AA system S″ in which the functions of the CU are incorporated into the PC itself. This implementation may be viable when the PC 10 can be relied upon to continuously run the sequence control software and is in a physical location within wired or wireless reach of all of the SEs 14. In this system, the PC's 10 audio components are used for local playback of audio segments over a single speaker(s) local to the PC 10 or wire/wirelessly connected to remote speakers. If the system is configured for multiple sequences with potentially simultaneous but different audio outputs, then one or more audio SEs may be used. An audio SE may have a single set of one or more voice/music/effect tracks it can play which may be factory programmed or downloaded from the PC in advance of playback. The PC 10 initiates playback of a particular track on an audio SE by sending it a short command. The PC 10 can stop or start playback of any track or download new tracks at any time. As this type of AA system typically requires a dedicated PC, it may not be appropriate for installations where the competence of the user to operate and maintain such a system is in question. It may also not be appropriate when a lower-cost system is desired, especially when the user does not already own a PC.

Any of the system control hierarchies in FIGS. 1, 2, and 3 may use wired or wireless communication techniques between the PC, CUs and SEs. If common hardware and a common communication protocol are employed for all PC-CU, CU-SE and PC-SE communications, then it would be feasible to use the same PC, CU and SE hardware in any of these three types interchangeably or simultaneously. For example, with an appropriate program or software, a system could be implemented in which some SEs communicate directly with the PC while, simultaneously, others communicate with one or more CUs, which, in turn, communicate with the PC.

According to some embodiments, the CU communicates with SEs that are intended to provide inputs or effect outputs from a sequence in that CU. Because there may be multiple CUs with multiple sequences each and many SEs all in one environment, according to one embodiment, the AA includes a method of associating each CU/sequence with the appropriate SEs. In addition, one SE might provide the same data to several sequences in more than one CU. One embodiment of a method to accomplish this association is the following process:
1) A sequence is started in a sensor discovery mode on a CU.
2) One SE to be associated with that sequence is turned on.
3) The CU receives information from the SE identifying the SE's sensor type and unique ID.
4) The CU looks for the next need for that sensor type in a list associated with the sequence. If there is no need for that type, then no further action is needed for that SE.
5) If there is a need, then the unique ID of that sensor is stored and associated with the sensor in the sequence for which it will provide data.
6) If the sequence requires several of the same types of SEs, then prompts on the CU display can indicate which SE to turn on next.

Alternately, or in conjunction with the above steps, the CU can prompt the caregiver through turning on each SE needed by each sequence, one at a time, and confirming proper communication. In another embodiment, each SE has a button that is pressed when prompted by the CU. When the user presses this button, the SE sends a message to the CU indicating its type, unique code and that the button is pressed (not a normal data transmission), thus causing the CU to associate only that SE with the needed sensor input.

To support this process, each sensor type in each SE has identifying data sent along with its sensor data. Each identifier is unique amongst all SEs made. In one embodiment, this unique ID is provided by an integrated circuit in each SE that has a factory-encoded 16- to 64-bit code. In some embodiments, a transceiver circuit that conforms to the IEEE 802.15.4 specification provides this unique code or address. Multiple sensors in a single SE may be identified by a numeric suffix, appended by the SE processor, to this code.

While wired communication paths between PC, CU and SE components may be appropriate in some circumstances, wireless communication methods would eliminate the cables associated with such communication. Wireless communication can enhance the lifetime of the PC, CU and SE components by eliminating connectors that can malfunction and the clutter of cables that can be broken. Wireless communication also solves the problem of not having sufficiently long cables. Common standardized wireless communication methods suitable for use include WiFi, Bluetooth® and ZigBee®. In particular, some embodiments may use ZigBee® transceivers for PC-SE, PC-CU and CU-SE communications due to their low cost, low-power, and minimal interference due to the use of spread-spectrum radio technology. Protocols specified in the ZigBee® standard, IEEE 802.15.4, allow for point-to-point, star and mesh connections, thus enabling a very flexible physical arrangement of CUs and SEs in the user's environment. A mesh network is a group of independent sensors, controllers and output units (e.g., amplifier/speaker) that achieve communication of any unit to any other unit, regardless of topological layout and with very low power transceivers. A mesh network accomplishes this by automatically finding a path from one unit to another via one or more intervening units. The distance between the two communicating units may be too long for their direct reception, so units use the intervening unit(s), which is within range of each other, to accomplish the communication. Mesh networking of PCs, CUs and SEs may be useful in instances where, for example, a single CU needs to integrate data from multiple SEs in widely dispersed locations. In this case, the data from a SE for a particular CU may pass through one or more other SEs and/or CUs on its way to the intended CU.

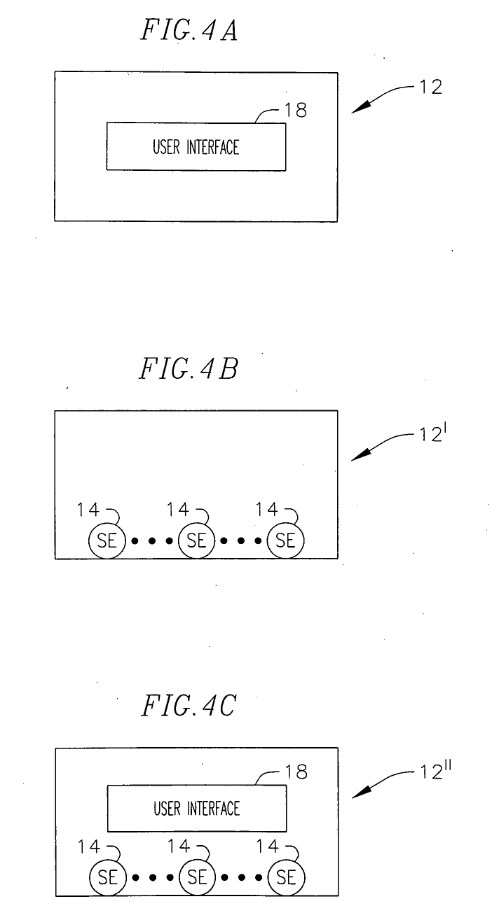

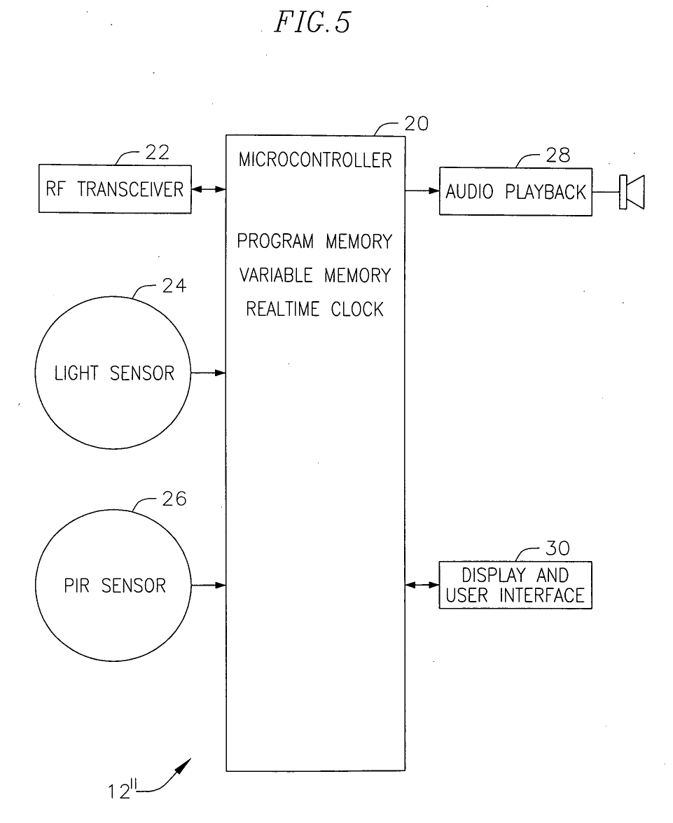

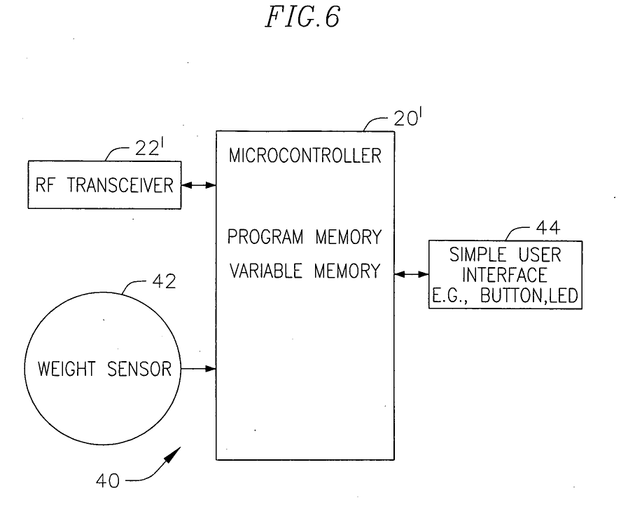

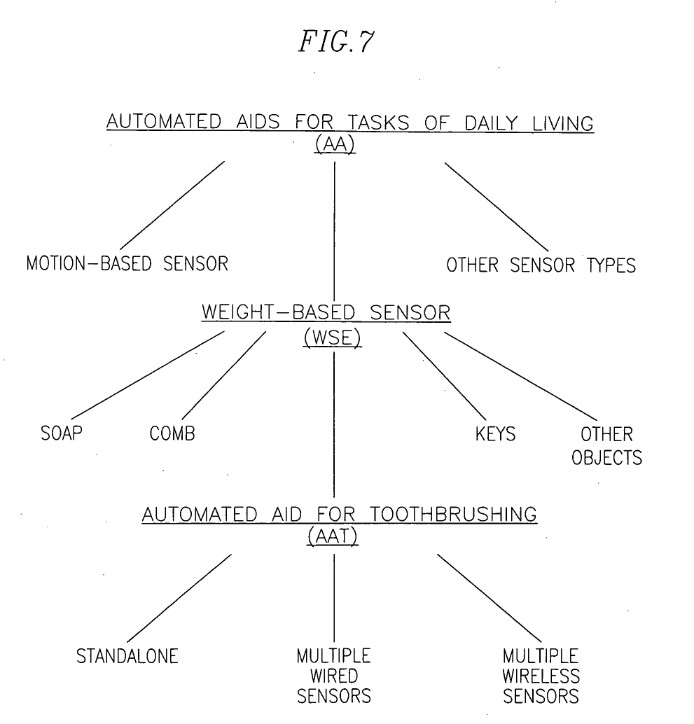

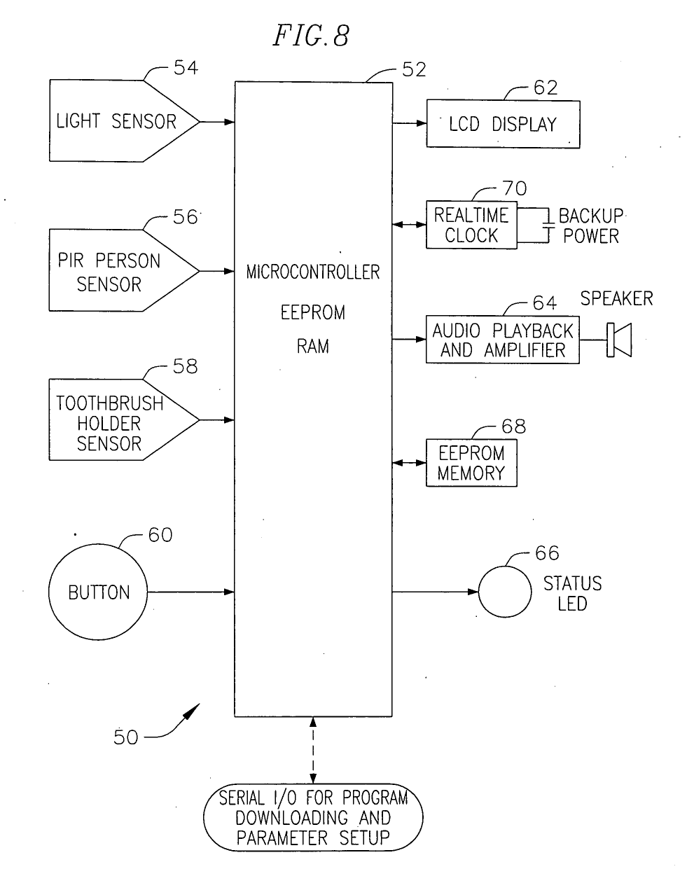

Depending on the type of control architecture in which a CU is used, its capability to directly interface with a user or caregiver may vary. FIGS. 4A, 4B and 4C illustrate examples of three CU configurations, any of which may be used in any type of system architecture. FIG. 4A shows a CU 12 with a built-in user interface 18 including a display and push buttons or keypad (if the intended interaction requires them). FIG. 4B shows a CU 12′ with no user interface, but some SEs 14 are included internal to the CU. For example, a CU and its audio output device may be built into a toothbrush holder which includes the brush sensor. FIG. 4C illustrates a combination of the above two designs where both a user interface 18 and some SEs 14 are included. This type of CU 12″ may be useful, again in the toothbrushing example, when a single unit is desirable, but the caregiver has the capability to make adjustments to the sequence without the use of the PC. For instance, the caregiver can adjust the coaching interval between exhortations to the user to keep on brushing. Having at least a simple user interface in a CU is beneficial particularly in the case where the CU sequence is configured by a doctor or caregiver remote from the site of use and no PC is available at the site. The ability to easily accommodate the fine points of an individual user's interaction with the system is important to the success of the AA in achieving its goal of improving the life of the user. Thus, in some embodiments, iteration may be used (i.e., select the initial sequence; let the user try it; monitor the compliance level; if the level is too low, adjust the sequence or some parameters of the sequence; monitor compliance for success). Some embodiments of a CU may include a more or less sophisticated user interfaces in lieu of the PC to accomplish all or part of this iterative process.

A display in a CU with a sequence that echoes audio prompts as text can be an important part of the coaching process for users who have lost part or all of their hearing. In some embodiments, displays of text and/or graphics or simply blinking LEDs or a small strobe light may work together with audio queues to attract and hold the attention of the user and explain the coached process. Blind users may benefit from audio prompts alone or in combination with a Braille display. Tactile effectors in objects the user may handle may also act as a means for communicating a next desired action, such as when to finish brushing.

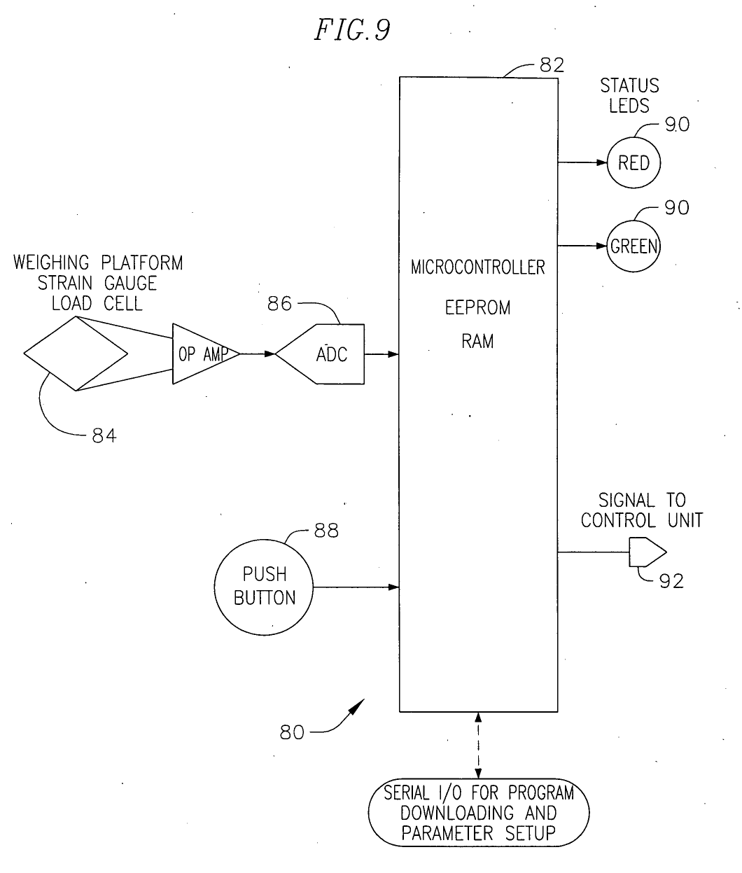

FIG. 5 illustrates one embodiment of a CU 12″ with the features illustrated in FIG. 4C. This CU 12″ includes a microcontroller 20, RF transceiver 22, light and PIR sensors 24 and 26, respectively, an audio playback subsystem 28 and a user interface 30. Additional SEs, such as a toothbrush holder, may be provided as independent units that communicate to the CU by means of the RF interface. The microcontroller 20 includes memory to store its program and downloaded sequences as well as variable memory (RAM) for runtime computation. This CU 12″ may also include a real-time clock that a sequence could use to establish, for example, the correct time intervals for the coached activity. As noted above, other implementations of a CU may include other combinations of hardware, appropriate to the coached activity, the physical form of the unit and cost objectives.

FIG. 6 illustrates one example of an SE, useful for applications involving weighing an object involved in the coaching process (such as a toothbrush, bar of soap or a set of keys). The SE 40 includes a microcontroller 20′, RF transceiver 22′, weight sensor 42 and a simple user interface 44 that may include a button and/or an LED. The microcontroller 20′ includes program memory in which a fixed program is stored that processes the weight sensor information and transmits it to a CU or PC. Memory is included for temporary process data. The user interface 44 may be as simple as a single LED to indicate to the user or caregiver that the unit is functioning normally, when a sensed event occurs and when it is time to replace the SE's battery. A single button may be pressed, for example, by someone besides the user to signal to the CU that someone besides the intended user has been detected (i.e., a “not-for-me” function). Some embodiments of the SE may have the capability to be downloaded with a modified process or parameters so that a single SE could be used for several applications requiring different computations of the sensor data. For example, sensing a toothbrush may simply involve determining the baseline weight of the cup and then signaling when the weight increases by a small amount, indicative of the brush and/or toothpaste tube being placed in the cup. In another embodiment, it may be desirable to use the same SE to sense the presence and weight of a bottle of water. In this case, the SE transmits any changes in weight, including the actual weight for further processing in the CU or PC. Other embodiments may execute more or less of the sensor processing in the SE rather than in the CU or PC. This architecture allows a very flexible, cost-effective and application-dependent division of responsibility between computational units.

One practical example of the application of multiple sensors of the same type communicating with a single controller is the toothbrushing application in a home in which there are several bathrooms. The user, in this example, may not always use the same bathroom during the selected brushing periods. In order to be assured that the user brushes her teeth no matter which bathroom is entered within a time period, toothbrush holders and brushes are placed in each bathroom. Any one of these holders can detect the user and offer the prompts. However, so that the user is prompted for a particular time period only once a day, any holder that causes the user to brush her teeth signals the others (or a single control unit) that the task was accomplished. Subsequently, when another unit detects the presence of the user, it will not duplicate the prompts. In one embodiment, prompts to someone entering the bathroom who is not the intended user can be cancelled when the person presses a “not-for-me” button on the SE or CU.

Communicating prompting status and/or coordinating all reminders/prompts through a single control unit has the advantage of providing a single point of contact to an external computer system or Internet connection. This connection may then be used for remote setup and parameter changes, such as changing a brushing period or adding an additional period. The connection may also be used for remote modification of reminding schedules, priorities, emphasis, etc. In addition, the connection may be used for remote monitoring of events and status, such as compliance statistics by date, time, etc. The connection may also be used to remotely enable/disable any units. Also, the connection may be used for automated communication from any AA unit to a remote caregiver, e.g., to supply refills or alert to emergencies. The connection may also be used for automatic notification to a caregiver of missed periods, faulty equipment, etc. Notifications and status may be provided via a web site or an automatically-generated email. Additionally, the connection may be used for remote, scheduled prompts, e.g., for doctor or dental appointments, medication refills, etc., including personalized verbal messages from the user's doctor or dentist. The connection may be also used to assist or to perform the programmable functions of the controller.

In one embodiment, a controller is separate from its sensors, integrates data and responses from all the sensor units and does the talking, either from an internal speaker or via remote, RF-interfaced speaker(s). Alternatively, the audio/indicator output may be a digital/audio watch/pendant worn by the user. This user-carried device may be fairly simple, and without much storage, receiving any data from the controller just before it is commanded to display or play. An AA according to one embodiment may also place a remote call to a landline phone or cell phone, e.g., via digital Voice Over Internet Protocol (VoIP). The AA may generate voice messages for status and/or for requesting responses as acknowledgments or parameter changes. The AA may also respond to voice and/or keyed prompts. Likewise, the AA may communicate with other electronic devices, for example, hand-held computers (such as Personal Digital Assistants (PDAs) or cell phones to deliver status information and acquire user inputs.

Networked sensors/controller(s) are lower in cost for a larger collection of reminding devices in comparison to a system in which each device has the controller function. In addition, networked sensors/controller(s) have smaller footprints for the portion of the system at the point of usage. Single-function, stand-alone control/sensor units may also have an expansion capability, allowing later add-ons of additional sensors and effectors, as desired.

Embodiments of the system, as described above, are intended for use by a single user. However, there may often be additional users, companions or caregivers in the house. Accordingly, some embodiments have the capability of distinguishing between people to provide the appropriate prompts to the correct person.

Several different methods may be employed to accomplish this discrimination. For example, a “not-for-me” button can be pushed if the system responds to the wrong person. Alternatively, users may wear a small rubbery bracelet or the like with an embedded passive RFID tag. The tag may be read when the person responds to an initial voice message and puts her hand near the unit (close range needed). The unit then addresses the person and tells her if it is her time to brush. According to another embodiment, users may wear a bracelet, as above, but the bracelets are distinguished by color. The units use a color sensor to distinguish users. In another alternative embodiments, users may wear an active RF or infrared tag. When the user is within about 10′ of the control unit (the PIR range) the CU receives the unique user ID and reacts accordingly. In an alternate embodiment, the tag may receive a RF or IR signal from the control unit, which causes the tag to respond with a code unique to the person. Rather than always transmitting in timed bursts, uselessly draining a small battery, a transponder uses much less power than a continuously transmitting device. This method is particularly well suited if the user is already wearing a voice output device, described above. The unit then responds based upon the unique times/needs of the detected person and can report status separately for each person detected. In other embodiments, the tag reader could be part of a SE, dedicated to this task or shared with other sensor or effector functions. However, since wearing anything is a potential problem for many users, especially if the tag should be put on first thing in the morning, some embodiments may use video face recognition technology or the like to distinguish between users and caregivers. In another alternative embodiment, when the unit senses a person, it may call out for identification in some way. For example, the unit may recognize the person's voice as unique and respond accordingly. According to yet another embodiment, separate sensor units may be used for each of a number of users, for example, several toothbrush holders in one bathroom. When any user enters, a generic message asks her to pick up her own brush. When she does (self-identifies) then the system knows which user to address. The AA can then run a sequence appropriate for that particular user or prompt her to brush based on her individualized time of day or compliance history.

In addition, some embodiments may embed the sensors and the means to convey the sensed information to a control unit inside of or on the surface of an object. Whether or not a sensor is attached to an object, it is often the goal of an AA to allow the use of off-the-shelf objects. Using such objects is not only less costly than customized objects, but the objects are also more familiar to the user. The familiarity encourages greater compliance, and use of existing objects makes the system more affordable.

### Mobile Applications

In many AA applications, the location of the PC, CUs or SEs may be in fixed locations in a home or adult care facility. For example, the PC may be in a study and a CU may be in a bathroom along with several SEs for a toothbrush and soap, for example. However, there are instances when a CU and/or SE may need to be mobile.

For example, a caregiver may be in any location within a home at the time that she needs to be notified that the user is in the process of a coached activity or needs help. Much like a remote baby monitor allows a caregiver to listen for problems in a nursery, a portable CU allows a caregiver the flexibility of being at a location different from the location of the user and SE. In some embodiments, the caregiver may carry only an enunciator SE, such as a voice output device. In this case, the CU may be local to the SE that is measuring the user's compliance. The CU sequence may call for the remote SE/enunciator to notify the caregiver in certain circumstances (e.g., the user has not responded to prompts to brush her teeth) or simply echo the voice/music it is producing locally. In other embodiments, the caregiver carries the entire CU and the user receives coaching feedback via a remote SE.

In other embodiments, a remote or local CU communicates with a mobile SE. This embodiment may be used when the function of the SE is to monitor an object that moves with the user, such as a sensor that monitors the wetness of a diaper.

### Weight-Based SES

One embodiment of an AA utilizes a sensor that can weigh a variety of objects for the purpose of providing the AA control unit with feedback as to whether the user has picked up or replaced the object or otherwise used a portion of the object. For example, the sensor may be used to detect a toothbrush, soap or hairbrush. It might also be used, for example, to determine if toothpaste is used or how much of a drink is consumed.

A SE based on this type of sensor is a Weight-SE (WSE). A Weight-SE is the basis of one embodiment of an AA referred to as a Weight Based AA (WAA). A WAA includes a weight sensor attached to an object carrier. The carrier is adaptable to holding a variety of objects, such as soap, a toothbrush, or a pill dispenser depending on the WAA application, as suggested above. The technology used to construct the weight sensor, whether using a load cell, a spring-loaded mechanical or electronic switch or other means is selected based on various factors depending on the application. These may include the weight range of the weighed object and resolution of the measurement. For example, when detecting a toothbrush in a holder, a weight range of about 100 g may be adequate with a resolution of about a gram, since a typical toothbrush weighs between about 10 and about 15 g. However, determining how many pills are taken from a dispenser that holds a number of other pills may require a range of about several hundred grams and a resolution of about a 10th of a gram.

One particular application is a WAA that coaches the user to brush her teeth, herein referred to as an Automated Aid for Toothbrushing (AAT), discussed in further detail below. The relationship between the AAT, the WAA and other AAs is illustrated in FIG. 7. FIG. 7 shows that the use of a Weight-SE is but one of many possible object sensor methods that could be used to implement an AA. It also shows that one of those objects, i.e., a toothbrush, could be the focus of a set of implementations of a toothbrushing reminder system (an AAT).

According to some embodiments of the present invention, the WAA is an AA that coaches a user to correctly perform an activity with an object on the tray. Like a caregiver, the WAA is situationally aware. It knows the series of steps that should be accomplished to complete the activity. It is aware of the time, the presence of the user and the contents of the tray. This allows the unit to provide appropriate spoken instructions.

The WAA may be used for anyone, but may be particularly useful for individuals with impaired memory and impaired awareness of time and duration. The unit can be programmed to give simple instructions for minor impairment or detailed instructions for severe impairment.

The WAA, like a valet, tutor or coach, has a need to help and it expresses this desire when appropriate conditions are met. One feature of this unit is that it speaks out, prompting, rewarding and correcting the user through the task.

Besides sensing the weight of an object, the unit may also integrate data from other sensors that can detect, for example, user presence or room light level, with time of day and various user-specific profile parameters to provide a situationally-aware, personalized coaching sequence for the user.

If the unit can't discriminate between different people, it may be located where only the intended user would be present. However, some embodiments deal with this problem by providing, for example, a “not-for-me” button that can be pushed if the system responds to the wrong person or providing other methods of discriminating between users, as described in detail above.

### Motion-Based SES

Motion sensors detect the movement of an object or appliance, typically as an object or user-action sensor. A SE incorporating a motion sensor is a Motion-SE (MSE). The MSE communicates motion data to an AA via wireless RF or IR, sound, ultrasound, wire, optical fiber or other means. An AA sequence could then use this information to infer that a user is moving an object or appliance.

Motion can be detected by many means. For example, integrated circuit accelerometers may be used that detect acceleration as well as orientation with respect to the earth. Alternatively, balls resting on wires may be used, in which movement of the balls or the wires indicates motions. This method is used in window break detectors that in turn are used in burglar alarm systems. As another example, a mass, supported by an elastic device like a spring, may be used. In this configuration, the mass moves due to acceleration or rotation with respect to the earth, and the motion of the mass is detected. This type of motion detector could be very inexpensive to produce. Additionally, video systems operating in visible or infrared wavelengths can detect objects coming into or out of the field of view, or motions of those objects while in the field of view. Also, Global Positioning System (GPS) devices attached to an object can provide absolute position data with limited resolution, for instance, to determine what room a person or object has moved to.

As an example, a motion sensor attached to a wheelchair or walker could be used by an AA to alert a caregiver if a user was attempting to move. This is useful, for example, if a caregiver needs to be present when a disabled person attempts to go to the bathroom.

As another example, an AA could be made to remind a user to take personal items when leaving his or her house. The product may use MSEs attached to all items a user would want to be reminded to take. The MSE may include motion sensor and a wireless transmitter. As the user approaches the door and starts to pick up items with attached MSEs, the AA would become aware of these items. Depending on the time of day and/or preprogrammed lists of items, the AA could verbally remind the user to pick up forgotten items on the list. Also, a receiver connected to the AA, outside the door, could monitor that the user in fact took the items. This would help to detect if the user picked up an item and then mistakenly put the item down, without taking it. An effector outside the home could remind the user to return and take the missed item(s).

In some embodiments, a MSE can include a sound-emitting device and a transceiver. This would allow the AA to cause the MSE to emit a sound or a message. This could be used to locate misplaced or lost objects attached to the MSE.

Video systems can recognize and detect the change in position of objects and/or people and/or animals in a visual field of view. This information could be utilized by an AA to instruct and monitor objects and appliances for activities of daily living. A video system responding to IR can detect if objects on a stove or cooking appliance are being heated. By monitoring the rate of change of heating of objects on the stove, an AA could use this information and other sensors detecting the presence of a user in the kitchen to determine if a stove, cook top and/or other heating appliance was left on without a user in the kitchen. This information could be used to prompt the user to turn off the appliance or sound an alarm, contact a caregiver, and/or automatically shut off the stove or cooking appliance.

A Passive Infrared (PIR) sensor can sense the body temperature of a person or animal. The PIR generates a signal when a warm object, like a person, moves in or through the viewing field. PIR sensors are may be used to detect intruders for a burglar alarm or to turn on a room light when a person enters. An AA can use PIR information to detect a person entering a room, moving near an object or appliance (like a toilet or shower), and/or leaving a room or space. This information alone or with information from other sensors allows the AA to monitor and coach a user through an activity of daily living.

A presence detector can detect when the user enters the bathroom, for example, so that the AA can instruct the user to put on deodorant. In one embodiment, an MSE is attached to an object, such as a deodorant applicator. The MSE data can be used by an AA to detect if the deodorant was removed from a counter or cabinet, sufficiently applied and replaced and to coach the user accordingly. In another embodiment, the MSE attached to the object is used in conjunction with a WSE in a deodorant holder. In this embodiment, the WSE data indicates when or if the user takes and replaces the deodorant and the MSE indicates more directly whether the user properly applied it. Sufficient application of the deodorant may be indicated by a particular movement signature (relationship over time of the x, y and z accelerometer axes). That is, data that indicates a general back-and-forth motion of application.

In some embodiments, a single AA can prompt a user to accomplish multiple activities of daily living. Each added activity might require a sensor to detect and/or monitor the use of an appliance or toiletry. For example, a single AA may prompt a user to put on deodorant, shave and comb his hair. The deodorant, shaver and comb might each require a sensor, attached to the object and/or to an object carrier, to detect and/or monitor their use.

Nonlimiting examples of activities that may benefit from coaching from AAs according to embodiments of the present invention include health monitoring and medication adjustment assistance, pet care, home control assistance, and dental hygiene.

### Health Monitoring and Medication Adjustment Assistance

Many individuals suffer from one or more conditions that require daily monitoring of one or more physical parameters and consequent periodic adjustment of medication. When such a person also has mild to moderate cognitive impairment, an AA may be particularly useful to ensure that the monitoring process is faithfully performed and that a caregiver or doctor is promptly provided with the information he may need to make the adjustments. An AA can also aid in making some of those adjustments through its capability to interact with caregivers at a distance. For example, persons with congestive heart failure need to monitor their weight daily. If their weight rises above a value determined by their doctor, then their medication should be changed. In one embodiment, an AA may daily remind the user to weigh herself on a scale interfaced to the AA. The AA may be programmed with the critical weight that requires change in medication. Also, the AA could store the daily weight and the user's rate of compliance. This data could be viewed periodically by the user or caregiver. In addition, the physician, his staff, or others could view the data over the Internet. If the person's weight increases above a threshold value, an alert could be sent via the Internet or a phone message to the physician, a caregiver or a relative. In another embodiment, a motion sensor may be attached to a medication container. If the person does not move this bottle, thereby implying that they did not take the medication, the AA could remind the person several times to take the medication. If the person still does not take the medication, the AA may store this information and/or notify interested people as described above.

One exemplary embodiment of an AA useful for reminding a user to weigh herself includes a scale in communication with the AA. In an alternative embodiment, the AA may include a PIR that detects when a person enters the room having the scale. An exemplary embodiment of an AA useful for reminding a user to take a medication may include a motion detector attached to a pill dispenser. In an alternative embodiment, the AA may include a pill dispenser or a scale that communicates with the AA.

Similarly, an AA can assist in compliance with regular blood pressure monitoring. An AA can prompt the user at appropriate times to take her blood pressure and enter the values into the AA for data collection, trending and remote reporting. Alternatively, the blood pressure monitor could be directly interfaced to an AA to further reduce the responsibility of the user and increase the reliability of the reported data.

Another typical situation requiring daily monitoring is insulin-dependent diabetics with MCI. These individuals should check their blood sugar at regular intervals and adjust their insulin dosage accordingly. An AA would be very effective at reminding such a person to use their blood glucose meter at regular intervals, coaching them through the process, collecting data and reporting the measurements or causing the measurements to be reported. An AA could also compute or obtain revised insulin requirements and prompt the user through the process of taking it.

Many medical conditions are treated with medications in pill-form. In one embodiment of an AA-enabled pill dispensing system, a pill dispenser stores a large quantity of several types of pills, each type in a separate container. The dispenser can count out any number of pills from any of the containers into a common dispensing area. After all the pills have been accumulated into the dispensing area, the dispenser makes the area accessible to the user, prompts her to take the pills, and monitors for compliance with its instructions. Unlike existing pill dispensers, the AA-enabled dispenser does not require a caregiver to count out each dose into separate containers for each medication period. Rather, the number and type of each pill is automatically dispensed at the time of dosage. This allows an AA-enabled pill dispenser to respond immediately, without human intervention, to a need for dosage adjustment from a local or remote caregiver or physician. This capability, coupled with monitoring and coaching a user through collection of physical data, as in the above examples, provides a way to further automate the timely adjustment of medications for users with MCIs.

### Pet Care

Pet companionship can be very therapeutic. However, a person with mild impairments might not be capable of taking care of a pet without assistance. For example, a forgetful person might not give the pet water or might not remember to feed the pet. A person with more significant impairments might forget that he or she just fed the pet and consequently feed it repeatedly.

One embodiment of an AA could help such a person provide the proper care. For example, a water bowl with a sensor detecting low water could cause the AA to notify the impaired person to fill the water bowl. If the person does not complete the requested action after repeated prompts within a preset time interval, the AA could send a message via the Internet or telephone to another individual who would correct the situation. Sensors for this application may include a scale to weigh the bowl of water or a water level detector to sense when the water is low.

At programmed intervals the AA could also instruct the person to feed the pet. Depending on the level of impairment, the AA could instruct the person where to find the pet food, where to find the can opener to open the can, or scissors to open a bag of dried food. Switches attached to cupboards, drawers and the refrigerator door, would inform the AA if the person is performing the activity correctly or requires further instructions. A weight sensor on the food bowl and/or motion detectors on the pet food containers could inform the AA that the person is repeatedly feeding the pet and advise the user or a caregiver accordingly. Also, the AA could instruct the user that she already fed the pet and that she should not feed the pet again.

### Home Control Assistance

Home automation systems monitor and control many appliances, functions and systems within and surrounding a home. According to one embodiment, an AA can replicate and/or utilize home automation devices within the context of its monitoring and coaching functions. For example, an AA can communicate with industry standard X10 control modules for control of lights and appliances. Also, an AA could turn on the lights at night when a user gets up to go to the bathroom as soon as she sits up or gets out of the bed. This AA helps eliminate the potentially dangerous situation in which the user tries to find a light switch after leaving the bed. The AA could also shut off the lights when the user returns to bed.

Any number of sensors could be used to determine if the user got out of bed. For example, a sensor on the bed may detect when the user gets up. This sensor could be a load cell to measure a change in weight. Alternatively, the sensor may be a switch floor pad next to the bed. Another exemplary sensor is a motion detector on the user's walker. Yet another exemplary sensor is a PIR sensor that detects when the user sits up or moves away from the bed.

In another embodiment, the AA could operate in conjunction with a security system, opening and closing window blinds and setting the alarm based upon not only time of day but also the activities of the user. That is, some users may forget to set the alarm or attempt to leave the home without disabling it. An AA can consistently remind the user to do these tasks or do them for the user based upon sensor data monitoring the user's status. For example, if the user has exited the bathroom and then got into bed and shut off the room light, the system recognizes that she has retired for the night and sets the alarm. Likewise, if the system detects that the user has left the bed and has done other activities after some preset time, the system could turn off the alarm or prompt the user to turn off the alarm.

In addition, according to one embodiment, an AA can help a user secure a residence. For example, at night or other preset time or condition (such as user activity), the AA could activate actuators to close doors, windows, drapes, window shades and lights. If, after prompting, the system detects that the desired windows, doors, etc. are not properly closed, or the alarm is not set, the system can activate actuators to complete the tasks or contact a caregiver to correct the situation.

### Dental Hygiene

Regular toothbrushing is one of the more common conditions requiring supervised assistance. The lack of regular attention to dental hygiene can lead to costly and unhealthful consequences. For instance, twenty-three percent of 65- to 74-year-olds have severe periodontal disease (measured as 6 millimeters of periodontal attachment loss). At all ages, men are more likely than women to have more severe periodontal disease, and at all ages, people at the lowest socioeconomic levels have more severe periodontal disease. In addition, about 30 percent of adults 65 years and older are edentulous (toothless), compared to 46 percent 20 years ago. These figures are higher for those living in poverty. Also, most older Americans take both prescription and over-the-counter drugs. Likely, at least one of the medications used will have an oral side effect—usually dry mouth. The inhibition of salivary flow increases the risk of oral disease because saliva contains antimicrobial components as well as minerals that can help rebuild tooth enamel after attack by acid-producing, decay-causing bacteria. Individuals in long-term care facilities are prescribed an average of eight drugs. At any given time, 5 percent of Americans aged 65 and older (currently some 1.65 million people) are living in a long-term care facility where dental care is problematic. Dental and gum related diseases could cause more serious infection throughout the body. Dental problems can even accelerate the need to move an aging family member to an assisted living facility at greatly increased cost. If the aging person can't pay for dental care, then their relatives or friends should, providing an incentive to get the aging person to brush their teeth.

Vargas, et al. reports in “The Oral Health of Older Americans” that “unfortunately, financing dental care for older persons is particularly difficult compared with other age groups, in part, because there are no Federal or State dental insurance programs that cover routine dental services, and only 22 percent of older persons are covered by private dental insurance. Consequently, dental care is unreachable for many older persons living on a fixed income. Yet adequate oral health care is important for all older adults, as it is for other age groups.” In addition, according to a May 2000 report by the Surgeon General, “many elderly individuals lose their dental insurance when they retire. The situation may be worse for older women, who generally have lower incomes and may never have had dental insurance. Medicaid funds dental care for the low-income and disabled elderly in some states, but reimbursements are low. Medicare is not designed to reimburse for routine dental care.”

Brushing teeth is one of the many personal care tasks that help to prevent future dental and health problems. As a person ages they may simply forget to brush. As their memory deteriorates, they might need to be coached through the activity.

According to one embodiment of the present invention, providing an AA to get a user to brush her teeth reduces the amount of work required by the caregiver, thereby helping to reduce caregiver burn-out. Often, the ultimate solution to caregiver burn out is to put the aging person in an assisted living facility. In an effort to prevent caregiver burn-out and delay, if not altogether prevent, placing the aging person in an assisted living facility, an AA according to one embodiment of the present invention reminds the person to brush her teeth and guides her through the process. This AA is discussed in more detail below.

Automated Aids for Toothbrushing

According to one embodiment of the present invention, an automated aid for toothbrushing (AAT) is one exemplary embodiment of a Weight-SE. This device may improve regularity of toothbrushing of a single adult living alone (either at home or in an assisted-care facility), or of children, whether normal or disabled, such as autistic children. However, this example is provided for illustrative purposes only, and is not intended to limit the scope of the invention.

The AAT according to this embodiment may include a tray to hold the user's toothbrush-holder (e.g., a cup). The tray weighs the user's toothbrush holder and, separately, the toothbrush and then calculates the difference in weight to detect when the brush is in the holder. This allows the use of any size, color or shape of toothbrush and a user-selected holder, thus minimizing behavioral changes and maximizing familiarity. An electric toothbrush stand with an electric toothbrush may also be used. The unit uses the weight information to determine if the user has removed the brush from the holder or replaced it. The tray or cup holder SE may be sufficiently small so that it can be placed in the same location on the bathroom counter where the user previously stored the toothbrush. Alternative embodiments of AATs may use an accelerometer embedded in the toothbrush to detect that the user moved the toothbrush, eliminating the need for a separate tray and/or holder.

In one embodiment, the AAT has an LCD to show the time and to assist in programming, a motion detector to sense the user's presence and a light detector to sense when the room light is turned on. It also interacts with the user via a waterproof speaker, an LED indicator and a touch pad.

When the AAT detects the user's presence during an appropriate time period, the unit “talks” the user though the tooth brushing process. The user or her caregiver may select one or more reminder periods, for example, an AM and a PM period.

The unit's controller may use a set of pre-recorded messages to communicate with the user. All or part of these messages can be recorded by a caregiver. This allows a familiar voice to talk to the user, if desired.

In another embodiment, if the user brushed their teeth in the morning and then picked up the toothbrush before the next designated time period to brush, the AAT may prompt the user to refrain from performing the task again. For example, the AAT might say, “You already brushed your teeth this morning. Please put the toothbrush back in the holder.”

In this embodiment, the message that the activity was already completed might have a time period from when the activity was completed to some arbitrary time. For example, the morning brushing time period might be between 8 and 10 AM. The time period to give the message that the user already brushed their teeth might be from the time the user did brush their teeth in the morning until noon. Before noon, the message might be, “You already brushed your teeth this morning. Please put the toothbrush back in the holder.” After noon, until the beginning of the evening brushing time period, the message might be, “Please wait until after dinner to brush your teeth. Please put the toothbrush back in the holder.”

Embodiments of the AAT may be powered by low voltage and should not need UL approval. The unit may have no external moving parts. Much like an electric toothbrush, it is waterproof and not affected by residual toothpaste.

AATs may be useful for a wide variety of people, nonlimiting examples of which include people of any age needing a reminder to brush their teeth; people with impaired memory needing coaching assistance through the steps of toothbrushing; people with impaired concepts of time needing periodic reminders to continue to brush; people with forgetfulness caused by injury, stress, or medication; aging adults; forgetful children; and children and teens with orthodontia who forget to brush.

The cost of the unit is justified by the savings its use can provide—savings that may be needed for other costs of care. If the aging person is paying dental-care costs, each dollar spent is one less dollar for other aspects of their care or in their estate. It is one dollar closer to the date when family members have to start supporting their parents or one less dollar that someone can inherit. If family members are sharing dental costs, every dollar saved might be one less dollar to argue over. Thus, an AAT might be purchased as a way to save on the cost of dental care incurred by users, caregivers, relatives, assisted living facilities, and those with the financial responsibility for the oral care of users.

AAT Functional Description

In one embodiment, the AAT includes two units—a controller (a form of CU, a PC, and/or a remote computer or server) and a holder (in some embodiments, a form of Weight-SE). The controller integrates all sensor functions and communicates with the user. It receives one digital signal from the holder to indicate whether the brush is in the holder or not. The holder senses the toothbrush holder (e.g., a cup) and the brush to provide this signal.

As shown in FIG. 8, the Control Unit 50 includes a microcontroller 52 with a number of input and output devices. Inputs may include a light sensor 54, a passive infrared (PIR) sensor 56, the toothbrush holder sensor 58, and a push button 60. Outputs may include an LCD display 62, an audio playback subsystem 64 and a status LED 66. The microcontroller 52 incorporates internal RAM and EEPROM memory and is interfaced with an external EEPROM 68 to store compliance statistics. The microcontroller 52 also communicates with an external real time clock 70 for time-of-day information. The clock may be backed up by an ultra capacitor so that the time is maintained through power outages lasting several days.

FIG. 9 illustrates the components of the holder according to one embodiment. As shown in this FIG. 9, the holder 80 includes a microcontroller 82 with several input and output devices. It obtains the weight of whatever object(s) is placed on a weighing pad 84 by means of a Wheatstone bridge load cell. The output of the load cell is amplified, scaled and converted to digital data by means of an analog to digital converter 86 with a bit resolution adequate to discriminate the presence or weight of the object(s). A button 88 provides a user input for a “not-for-me” function, initial pairing of the SE to a sequence or any other sequence-based user interaction. The microcontroller 82 also has three outputs. Two outputs are LEDs 90 for user setup and brush-in-holder indications. The third output 92 signals the controller that the brush is in or out of the holder.

Other embodiments may have different components of the controller and holder. For example, some embodiments may combine all of the input and output devices into a single unit with one microcontroller. Other embodiments may include more than one external holder unit or interface these holders to a controller by means of RF signals. Further, alternative embodiments may detect movement of the toothbrush using other forms of sensors such as an accelerometer embedded in the toothbrush, with, for example, a wireless transmitter that sends acceleration data to a receiver at either the holder or the controller.

FIGS. 10A, 10B and 10C are flowcharts describing the operation of one embodiment of an AAT. Referring to FIG. 10A, the system starts normal operation following user configuration of the time and several operating parameters. These parameters may include, but are not limited to, maximum desired brushing time, minimum acceptable brushing time, coaching interval, waiting time between the initial greeting and the start of brushing prompts, waiting time to remove the brush from the holder, and waiting time to replace the brush in the holder.

The system then waits for three initiating conditions to be simultaneously met: 1) room light ON; 2) a person approaching the unit; and 3) the time of day falling in one of two reminder periods (e.g., an AM period and a PM period). If all these conditions occur at the same time, then, after a short musical introduction, the unit speaks “Good morning” or “Good Evening,” or the like and waits several minutes while testing the button. If the button is pressed during this interval, the unit assumes that someone has thus indicated that they are not the person intended for the prompts. This is a “not-for-me” function. In this case, the unit waits several minutes for the person to leave the bathroom, and then begins again to wait for the three initiating conditions. If the button is not pressed within the wait time following detection of the initiating conditions, then the unit speaks “Please remove the toothbrush from the holder and brush your teeth,” or the like.

FIG. 10B continues this process by starting a timeout while waiting for the brush to be removed from the holder. If too much time goes by before the brush is removed, then the system counts the timed attempt. If more attempts are permitted, then the system waits a fixed delay interval and increments a delay count. If the maximum number of allowed delays is completed, then the system speaks “Please take the brush and brush your teeth” and returns to wait for the brush in the holder.

If more delays are allowed, then, as shown in FIG. 10C, the system speaks “Thank you for taking the toothbrush. Please put some toothpaste on the brush and brush your teeth,” or the like. The system then starts a replacement timer and checks for the toothbrush in the holder. If the brush is not in the holder, then the elapsed time is compared to the correct brushing time. If the brushing time has not been reached yet, then the system checks if it is time to coach. If it is, the system speaks “Please continue to brush,” or the like, and returns to check if the brush is in the holder.

When the brush is replaced into the holder, the system checks if less than half of the desired brushing time has elapsed. If so, then it speaks “Please take the brush from the holder and brush your teeth,” waits five seconds and returns to wait for the brush to be removed from the holder, as above. If the user has completed more than half (but not all of) the programmed brushing time, then the system speaks “Please take time to brush more thoroughly” and continues at the point marked D.

When the proper brushing time has been reached, then the system speaks “OK, you have brushed enough,” or the like. A brush replacement timer is then started. The system next checks for the brush returned to the holder. If it has not, then the time is compared to a maximum replacement time. If the replacement time has not been exceeded, the system loops back to check for the brush in the holder again. If the time has been exceeded, then the system loops back to the “OK . . . ” prompt. When the toothbrush is finally put back into the holder, the system speaks “Thank you. Please floss your teeth after brushing,” or the like. If the system had been operating in an AM period, it switches to waiting to detect the user in the PM period. Likewise, if it was operating in the PM period, it switches to AM and resumes its wait for the user.

In an alternate embodiment, the unit maintains the attention of the user between prompts by playing music. Also, to reward the user for complying with the sequence, the AAT might play a song or tune the user likes, and a display might show an image of fireworks exploding, following replacement of the brush in the holder. For a young user, the AAT might say a different joke or play a different tune every day. The particular rewards or musical segments may be configurable along with the programmatic sequence or behavior of the unit based on sensor inputs, effector outputs and the user's responses. The musical segments may come from any digital source such as iTunes® or other music or audio effects stored on or downloaded to the user's computer.

Verbal or graphic prompts also may originate in the user's home computer, downloaded from the Internet or recorded locally. Local recording allows the caregiver to use his/her own voice or likeness or that of another family member or doctor for prompts. Some users will respond better to a voice or image of someone who is more familiar to them, someone with more authority or even their own voice. For example, an older person may respond better to the voice of their dentist or a grandchild than that of some other caregiver or someone unknown to them.

According to some embodiments, the AAT prompts the user to remove or replace the toothbrush in the holder. The AAT receives feedback indicative of the user's response by sensing whether the toothbrush is in or out of the holder. In one embodiment, a toothbrush holder subsystem of the AAT uses a method for sensing these conditions that employs a load cell weighing platform configured to carry the toothbrush holder. The subsystem sends a single signal, toothbrush in or out of the holder, to the controller. To generate this signal, the holder subsystem may differentially weigh the holder and the brush. These weights are determined in a calibration procedure that is initiated each time the holder is powered up. Once these weights are determined, the presence or absence of the brush is continuously signaled to the controller.

FIGS. 11A and 11B are process flow charts for one embodiment of a toothbrush holder detection subsystem. As shown in FIGS. 11A and 11B, the green and red LEDs are used to signal the person setting up the system, e.g., the user's caregiver, through a short sequence of actions to calibrate the holder. The holder initially expects the platform to be empty, and waits until the detected weight is less than one gram to continue. This aids recalibration in instances where the cup and brush are still on the holder when the calibration procedure is started. When the user removes any object from the platform, the unit begins to blink the red LED, indicating that the cup alone should be placed on the platform. When the unit detects a weight that is more than about 10 grams more than the unloaded weight, it stores this weight as the cup weight. If the cup weighs more than a value of about 10% less than the platform's load limit, then the red LED is turned on and the process returns to waiting to be unloaded.

Next, if the cup was an acceptable weight, then the unit briefly blinks the green LED to indicate success. Again, the red LED blinks to indicate that the toothbrush should now be placed in the cup. When the unit detects a weight of the cup plus about 5 grams, it determines the brush weight as the total weight minus the cup weight. The unit now turns on the green LED to indicate success and as a brush-in-cup condition. Subsequently, when the brush is taken out of the cup or placed in the cup, the green LED indicates the unit's recognition of this condition. This compliance feedback condition is also signaled to the controller. In other embodiments, the initial calibration process described above could be simplified to automatically recognize the brush in a known-weight cup, or to automatically identify the brush based on a sequential increase of weight of the cup, then the brush. In general, the caregiver could be guided through any calibration procedures by voice prompts in addition to, or in lieu of, other visual indicators.

In some embodiments of the weighing subsystem, the platform is shaped in such a way that, instead of carrying a cup, it is designed to hold some other object(s) that is the subject of user compliance. For example, the platform may incorporate a box that could hold a denture, a pair of glasses, a hairbrush or a set of keys, for example. Some embodiments may use the differential weighing method, while others may only detect presence or absence of an object. In some cases, the differential weighing capability may be used differently than in the case of the toothbrush holder. For example, the platform may hold a quantity of water or cleaning solution with dentures in it. The controller can then prompt for taking the dentures from the solution as well as prompting to periodically change the solution.

### Adaptation to User Needs

The AAs according to embodiments of the invention allow users to help their caregivers add and change functionality to suit the evolving needs of the user. Functionality can be changed by changing the program or sequence of the AA and by changing the type and number of sensors. As used herein, “program” refers to a set of instructions to be executed by a programmable component in the controller (i.e. CU and/or PC), and “sequence” refers to the steps required for a user to complete the subject tasks, including the set of instructional cues used to prompt the user to complete the steps. Finding an optimal sequence, numbers of sensors and types of sensors may require the person implementing the AA to observe and test various implementations over time. The person implementing the AA can buy the least expensive AA and then purchase more sensors as may be needed. This flexibility may be very useful for a person implementing an AA for a user with dementia. The deficits from dementia are often unique to each user. Also, the needs of the user may change with time, requiring either more or less detailed instructions to perform an activity of daily living. The change in the user's needs might require a change in the program and the type and number of sensors.

For example, for proper hygiene, an individual should wash his hands after using the toilet. Some individuals, such as those that are forgetful, might need only a verbal reminder after he or she leaves the toilet. The reminder might be, “Please wash your hands,” or the like. The AA to implement this might use one or several types of sensors. In one embodiment, these sensors could include a floor mat switch or PIR sensor next to the toilet to detect the presence of the user and a sensor that detects when the toilet has been flushed.

A user with progressive memory loss and progressive dementia, however, might need more sensors to allow the AA to appropriately instruct and monitor the activity of washing hands. The person implementing the AA might have to observe the user over time and change the program and add sensors as needed. Sensors to detect additional user actions may add additional instructions and monitor to the “wash the hands” activity. For example, a sensor could be added that detects when the sink faucet is turned on. The AA could use this information to repeatedly remind the user to continue to wash her hands. This sensor may also detect if the user turned off the faucet. After a programmed amount of time, if the faucet is still on, the AA may remind the user to turn it off.

The person implementing the AA might then observe that the user often forgets to use soap. Another sensor could be added that detects if the soap was moved or if a pump bottle of liquid soap was used. This information allows the AA to instruct the user to use soap and, if the sensors indicate that the soap was not used, remind the user again. Likewise, sensors may detect if the toilet was flushed, the toilet paper was moved and the towel moved. The person implementing the AA could add these sensors and modify the sequence as needed to add appropriate instruction for a user.

As another example of AA adaptation to user needs, consider the care of a person with Alzheimer's disease (AD), a daunting task for a caregiver. As the disease progresses, the person with AD may require constant monitoring. Each activity might have to be explained over and over. The deficient activity will be unique to each person with AD. Thus, adaptability of an AA is particularly desirable for this need. For example, a person with AD often gets up in the early morning hours to use the bathroom. If he is unsteady and often falls, he could injure himself. Implementing a single CU with one or more sensors and corresponding sequence additions could assist his caregiver. The sensor could include, for example, a sensor on the bed to detect when he gets up. This sensor could be a load cell under the bed to measure a change in weight or a switch floor pad next to the bed. Alternatively, the sensor could include a motion detector on his walker. In addition, the sensor could include a PIR sensor to detect when he moves away from the bed.

The AA could fuse information from a number of sensors to alert the user or caregiver. For example, the AA could sound an alarm to get the attention of the caregiver (if, for example, the caregiver sleeps in a different room). Also, the AA could have a wireless SE next to the caregiver that gives both an audio alarm and a message that the person with AD has gotten out of bed. The AA could also give an audio message to the person with AD to stay in bed until the caregiver arrives. Additionally, the AA could turn on a light in the room. Also, the AA could send a message to a local PC and from there, over the Internet, to a more remote caregiver.

### Automatic Adaptation

As described above, adaptation to a user's needs may involve monitoring of compliance data collected by an AA and/or observance of the user by a caregiver. The caregiver may then modify the sequence or parameters of a sequence to improve compliance or change the desired behavior in response to the user's compliance history. For example, a parameter may affect brushing time, the amount of water the user should drink in each coaching interval or items the user must remember to take when leaving home.

These changes may be easier or more timely or accurately performed in an automatic manner by the AA itself. Accordingly, in some embodiments, the computational unit and/or the sensors and effectors may learn a pattern over time based on the user's responses to the AA. The pattern might be a number of events happening at once, contingent on other events, a sequence of events over time or entered into an AA by any method by a user or caregiver. The pattern might also be a sequence of items detected by sensors and/or entered by any method by a user or caregiver. Manual definition of a pattern may include pressing buttons, keys or touch screen, by speech, via Internet, computer or by means of other electronic devices. A pattern may be a combination of events and items.

For example, an AA system may remind a user to take items when leaving her home. Each activity may need a different set of items. For example, when going to work, the user may take a briefcase, PDA, car keys and cell phone. When walking the dog, the user may take a dog leash, cell phone, doggie bags and dog treats. When going to the gym, the user may take a head band, exercise clothing, car keys and cell phone.

The user or caregiver may indicate to the system what activity will be done outside the home. In one embodiment, for each set of items, there is a distinctive key item. The key item is defined by manual definition and is associated with a particular activity. Exemplary key items include a leash for walking the dog or a headband for exercising. Sensors may allow the computational unit to infer which item(s) the person has taken. Over time, the system may record the set of items taken for each activity when the key item is also taken. If the user takes the key item, the AA may prompt her to take the other items associated with that key item. For example, when the leash is taken, the AA may prompt the user to also take the cell phone, doggie bags and dog treats. The system might modify this set over time as the user takes and/or does not take items. The system may make these changes automatically and/or require the user to confirm or deny the changes.

If the system includes a sensor to detect when the door opens or when the user moves toward it, then when the system infers that the user is leaving, the system may remind the user which items the user has not taken. In some embodiments, the AA remembers what items were last taken and reminds the user to replace the items when she returns, preventing the items from being misplaced for future use.

In another embodiment, the computational unit might infer an appropriate sequence of prompts to perform based on a learned pattern of events rather than a manually-defined key. Instead, the AA infers groupings of items into sets. The AA records what sets of items tend to be taken together just before the user leaves. Over time, and through a series of prompts and responses from the user, the AA is able to more helpfully suggest that some items in a set may have been forgotten. The AA may also remind the user to take all of a set when he has picked up only part of the set. The user may respond to the AA verbally or by a manual input such as a button or by taking an item sensed by a SE.

As another example of automatic adaptation, an AA may track the time that the user triggers the unit and automatically adjust the center and/or width of the time window in which the user is prompted to respond so as to better remind the user at times the user is accessible or amenable to prompting. For example, for the Automated Aid for toothbrushing (AAT), the AAT may start out with a toothbrushing AM period of 8-10 AM, but find that the user really wakes up on the late side of this range, so that with this fixed period, 50% of the time, the user misses brushing because she enters the bathroom at 10:15 or later. In this embodiment, the unit remembers a number of trigger times and then adjusts its window center to the mean trigger time so that the window is now 9:15 to 11:15 AM. This process results in a larger number of instances in which the user is coached to brush without a caregiver's intervention.

Other kinds of automatic adaptation may be used, such as playing different reward tracks to find the one best responded to, or changing time periods for maximum compliance. For example, for an AAT, the time given to put the toothpaste on the brush may be too short or too long. In this case, the AAT may bump this time up or down until the brushing time is maximized. Other types of adaptation are possible, such as, an AA may use data from an outside thermometer to suggest to the user to take an appropriate coat when going outside. In another embodiment, an SE containing a PIR sensor and audio output, mounted just outside the door, may ask the user if she has forgotten an item(s) shortly after the user has taken some items in a set but forgotten others.

### Sensor Fusion

Based on its applications, a particular AA may utilize one or more SEs. Each SE may be based upon one or more sensor technologies, as the examples above illustrate. An AA communicates with the SE(s) and integrates, or fuses the data from these sensors to carry out the process embodied in one or more AA sequences.

Thus, as algorithmically represented by a sequence, an AA utilizes sensor fusion to combine the inputs from several SEs to determine if the user has complied with the coaching suggestions. A single AA sequence might use data from one or more sensors. Some of these sensors may be contained within the CU while others may be in independent SEs, each containing one or more sensors. Sensors in SEs can be added as determined by the user as activities/sequences are added or modified, corresponding to the needs of the user.

For example, a user with minor memory impairment may only require a single simple voice prompt. A more seriously memory impaired or disabled user may require many sensors and prompts to instruct and monitor the proper use of an object or appliance and/or objects or appliances to correctly perform an activity or activities.

As another example, an activity like putting on deodorant might require a different number of sensors depending on the needs of the user. A user that needs only a verbal prompt, like “Remember to put on deodorant,” may require just one sensor, for example a PIR sensor or a floor mat switch, to detect when the user enters the bathroom. When the user is detected in a sequence-determined morning time interval, the AA may give the prompt. After some observation by the caregiver of this user, however, the caregiver may add a second sensor to detect that the deodorant container was actually lifted, moved and returned. The sequence would be modified accordingly to fuse the data from both sensors to provide an enhanced coaching process.

Sensors may be categorized generally by their use in sequences. Nonlimiting examples of sensor types include user presence sensors for detecting proximity or presence of a user, object sensors for detecting interaction of a user with an object, environmental sensors for detecting environmental conditions, and user action sensors for detecting actions of a user. User Presence or proximity Sensors may include passive Infrared (PIR) sensors, floor mat switches, optical beam-break sensors, capacitive sensors, and video sensors. Object Sensors may include weight sensors, acceleration sensors, capacitive sensors, optical beam-break sensors, inductive sensors, video sensors, and GPS sensors. Environmental sensors may include sensors for sensing environmental conditions such as light levels, heat, temperature, humidity, and moisture. User Action Sensors may include pressure sensors, acceleration sensors, acoustic sensors, and video sensors.

For example, an AA that is configured to instruct and monitor activities for proper hygiene when using a toilet might use multiple sensors to detect compliance in order to give appropriate instructions. For example, a presence sensor could allow the AA to detect when the user is near the toilet, a user action sensor could indicate if and when the toilet is flushed, a user action sensor could indicate if and when a toilet paper roll rotates, a user action sensor could indicate if and when the toilet seat is closed, a pressure or moisture sensor could indicate if and when the faucet is turned on or off, a WSE-based soap holder could indicate if and when the soap is used, and an object sensor could indicate if and when the towel is used. Sensors used to detect a user's compliance with the AA's instructions are referred to as “compliance sensors”.

The specific needs of a user determine which sensors and prompts may be needed by the AA to give sufficient and appropriate instructions.

FIGS. 12 and 13 illustrate two alternate processes an AA might implement to monitor and instruct a user in activities for proper hygiene when using a toilet. In such a process, the user is detected near the toilet and then is expected to use tissue, flush and wash her hands using soap, water and a towel. Such a process may be guided by inputs from several SEs. For example, a floor mat switch (e.g., crescent shaped) on the floor next to the front of the toilet. The crescent shape allows the user to stand anywhere around the toilet and still be detected. Alternate methods may include a PIR sensor near the toilet or a diffuse reflective optical sensor above the tank. Additionally, a load cell, or magnetic, optical, mechanical or capacitive switch on the toilet seat can detect a person sitting on the seat. Alternatively, a water level float switch or a pressure sensor with a tube that monitors the height of the water in the toilet tank may detect when the toilet is flushed. Also, an MSE in the toilet paper roll holder may detect when the roll turns indicating the user might be taking the toilet paper. In addition, a faucet turned on by diffuse reflected IR (as is used in many restaurant bathrooms) may communicate with the AA. A WSE holding a liquid soap dispenser may detect when the user pushes the dispenser pump and the amount dispensed. Alternately, a liquid soap dispenser on a platform with a switch may detect when the user pushes the dispenser pump. A WSE holding a bar of soap may detect when the user lifts the soap. A switch or motion detector on a towel bar may detect when the towel is moved

In each case, each sensor can be in a separate SE or combined in multiple SEs. Each SE can communicate to the AA via a wired (electrical or fiber optic) or wireless connection.

However, a particular user may have difficulty remembering to perform only part of the process. Accordingly, customization of a toilet hygiene sequence and selection of only those SEs needed to support the sequence permits appropriate adaptation to the particular user's needs. The generally expected hygienic actions after being at the toilet are use of tissue, flushing, turning on water, using soap and using a towel, in that order. The use of an AA can reduce noncompliance with these actions and therefore reduce the likelihood of illness for the user and others.

FIG. 12 illustrates a state diagram of one exemplary process for a user who only needs to be reminded to wash after using the toilet. The process remains in each state until one of the conditions is met as indicated on an arc exiting from the state. These conditions typically represent the onset or termination of a sensed value, such as the instant that the soap is taken from a Weight-SE soap dish or returned. A condition may also be defined to be when a timeout occurs of a clock period that was reset when the state was entered. The text surrounded in quotes illustrates an exemplary prompting phrase spoken when the state is entered.

When a flush sensor indicates to the AA that someone has used the toilet, the AA prompts with an initial reminder. If the user picks up and returns the soap in a nominal amount of time, then the AA may not bother her with additional reminders. If the soap is not picked up in a timely way, then the AA may prompt the user to do so. Similarly, the AA may wait for an appropriate time for washing and then prompt the user through returning the soap to the soap dish so that the soap will be readily found the next time it is needed.

FIGS. 12 and 13 are simplified for illustration purposes. An actual sequence may include counting and repeating prompting attempts and responding to all combinations of user responses and manipulation of objects. Also, verbal or graphic prompts would typically be longer and may include musical segments or other rewards for compliance as may be needed for a particular user.

FIG. 13 represents a sequence that may be used for a more seriously dependent user. Here, the data from six sensors, such as independent SEs, are fused to provide a more comprehensive coaching environment. In this embodiment, the process assumes that the user intends to use the toilet because she is detected to be near it (standing on a floor mat) for more than five seconds. To gently let the user know it is there and not miss a chance to coach later, the process issues an introductory prompt to use tissue. If the user does all of the appropriate actions in the correct order, then the process may only prompt with a general reminder to wash her hands. The process may be structured in such a way as to detect and prompt the user to correct typical errors in complying with the appropriate actions.

### Sequence Generation

Sequences govern the actions of the AA. A sequence is executed in real-time within an AA, whether the AA is a PC or a Control Unit. However, the sequence may be constructed elsewhere. In some embodiments, a sequence may be composed on a CU using a keypad and multi-line display. In other embodiments, a sequence may be composed using more graphical tools on a local or remote PC.

In either case, in some embodiments, the program that is used to compose the sequence stores it in a common representation. The PC or CU interprets this representation at execution time. In one embodiment, this representation is a state table providing all of the information needed by a general state machine running in the PC or CU. Each line of the table provides the state number, what to do when entering the state, what state(s) to go to upon one or more conditions, and so on.

For example, a state table for the sequence illustrated in FIG. 12 is shown in Table 2 below. This table includes one line for each condition that may cause an exit from a state. That is, there will be at least one, and perhaps more than one, line for each state. For each condition, the table provides a state to transition to upon the condition becoming true or false, unless a timeout occurs first, as described below. If no condition is specified, then the state will transition to the timeout state immediately after repetitions of the prompting phrase, if any, are completed. The “phrase” can be a reference to any audio file, whether speech or music, or an effect.

The Repetition Interval provides a time between repetitions of the phrase and the number of times the interval and phrase are spoken before the timeout starts. For example, if the repetition time is 5 seconds and the number of repetitions is 2, then the phrase will be played immediately after entry to the state, then a wait time of 5 seconds will elapse, then the phrase will be repeated (there is no wait time after the last repetition), and then the timeout is started.

If no repetition is given, then the phrase is only spoken once before the timeout starts, if any. The timeout interval begins after any prompts have been completed. The timeout length, in seconds, is provided, as is the state to transition to after the timeout. The timeout length may be specified as zero, in which case the timeout state is entered immediately following any spoken phrase repetitions. Transition to a state based upon a condition takes precedence over phrase repetitions and timeouts, except that a phrase, if specified, will be spoken at least once.

For example, with reference to FIG. 12 and Table 2, details related to other sequence-driven options are understood by those of ordinary skill in the art. One of these is data collection and storage for later use by a caregiver to assess compliance levels. Another is communications with a remote caregiver by phone or Internet or by an alarm SE worn by the caregiver or placed in another part of the house.

This tabular, data table format provides the information that a state machine execution process in the AA may use to perform the coaching sequence. Representing the sequence in this intermediate form allows a sequence to be generated by a variety of software tools without coding each sequence on the AA hardware directly. It also makes the representation of the sequence independent of the hardware implementation of the AA. Sequence generation tools can be developed for various computing platforms or for online website use that would be compatible with all AAs as long as they produced this common tabular representation of the sequence. The AA, such as a CU, may be downloaded with the table and any phrase data needed, keyed to match references in the table, prior to use of the sequence.

A particular PC or CU may be loaded with one or more sequences that may be locally or remotely user-selected to operate individually or simultaneously. Some sequences may communicate with a set of SEs used only by that sequence. Other sequences may share data from a SE. For example, a single PIR sensor may be used to detect a user's presence for both a toothbrushing as well as a toilet hygiene sequence.

TABLE 2
State Table
Simplified Toilet Hygiene Coaching Sequence

| | | State to go to on condition | | | Repetition Interval | | Timeouts | |
|---|---|---|---|---|---|---|---|---|
| State | Condition | TRUE | FALSE | Prompt | Time | Number | Length | State |
| 0 | Flush | 1 | | | | | | |
| 1 | Soap Taken | 3 | | Phrase 1 | | | 10 | 2 |
| 2 | Soap Taken | 3 | | Phrase 2 | 10 | 3 | 5 | 4 |
| 3 | Soap Returned | 0 | | | | | 20 | 5 |
| 4 | Soap Taken | 3 | | Phrase 3 | 5 | 3 | 10 | 0 |
| 5 | Soap Returned | 3 | | Phrase 4 | 5 | 2 | 5 | 0 |

Spoken at entry to the state and each repetition:
Phrase 1 “When you're ready, please wash your hands”
Phrase 2 “Please wash with soap and water”
Phrase 3 “Please take the soap”
Phrase 4 “Please return the soap to the holder”
Note:
Time values are in seconds

### Sequence Description Language

According to embodiments of the present invention, Sequence Description Languages (SDLs) are provided to operate AAs. SDLs are computer languages that, unlike more general purpose computer languages, are specifically tailored to operate Automated Aids for Activities of Daily Living. Although general purpose languages such as C or BASIC may be used to implement algorithms, they are very complex. If these general purpose languages were used to describe a coaching sequence, many more lines of code would be needed, making the language more difficult for the average caregiver to learn to write or understand. In contrast, the SDLs according to embodiments of the present include syntax that is specific to describing coaching sequences in a more straightforward way. Throughout this section, numerous examples are presented for illustrative purposes only. These examples are not intended to limit the scope of the present invention.

Introduction

According to the embodiments of the invention, a sequence written in an SDL includes a computer text file with more than one line of text. The first line may be a literal description of the sequence and may include a revision number. Each subsequent sequence line may be a numbered state, followed by a series of commands, each of which is in control when entered and stops when exited.

The first item in each sequence line may be the state number which can be in the # form or #.# form, such as 5 or 13.4. Commands separated by commas each execute once, in order. Spaces following commas are optional. Commands grouped by parentheses ( ) execute repeatedly, in order, until one such command causes a branch to another state. This group of commands is referred to as a loop.

Each command is identified by a two-letter Command Code prefix CC and one or two digit index numbers, n. The index number may be typically used to refer to one of several different instances of the logical or physical object referred to by the command.

### EXAMPLE 1

FG1 refers to Flag 1; PA3 refers to playing audio track 3.

Some commands can contain variables and can be set to a value.

### EXAMPLE 2

CCn=V assigns the value V to the item CCn.

The value associated with a command can be compared logically to another value. If the comparison is true, then sequence state G will be executed next. Logical comparisons <, = or > can be used.

### EXAMPLE 3

CCn=V_G If CCn equals “V” then the sequence line G is the next sequence line executed.

Some commands that include comparisons, with B added, can become armed interrupt commands. Armed interrupt commands are continuously tested at the same time that commands in the sequence states are executed. When interrupts are enabled and an armed interrupt command is logically true, then the sequence will branch to line G and the interrupt that caused the branch will automatically disable all interrupts. The same command with a D instead of an E disarms the interrupt immediately (stops its continuous background execution).

### EXAMPLE 4

CCn=V_EG

If a sequence line does not end with a loop or a GOn, then control will pass to the next state line unless other commands within the line, or an interrupt, cause another sequence line to be executed instead.

A command is parsed into its constituent components for execution as follows:

CCn O V “_” I G where:

CC [n][“=”|“>”|“<”][“V”|“VS”]“_”|[“E”|“D”][G]
CC—Two character command code, see list below
n—Index
O—Operator [“=”|“>”|“<”]
V—Value—numeric, character string or “FGn” the contents of flag n
VS—Character string of V when V is not numeric
“_”—Underscore character
I—Interrupt flag [“E”|“D”]
   E designates the command as an armed interrupt
   D disarms the command as an interrupt
G—Go state—state to execute next if test is true

Nonlimiting examples of commands include:
BRn—Brush sensor weight value in grams
DCn—Data Collection; Use DC0, DC1, etc. to save information about events
DEn—Data Entry; Get a value from a keypad/display device (n=0) or from a serial port (n−1)
DMn—Demo Mode (1 if in Demo Mode, else 0) for testing a sequence
DPn—Display string on an internal display (n=0) or send it to a serial port (n=1)
IE—IE=1 Enable interrupt(s), IE=0 Disable interrupt(s)
FGn—Flag (numeric storage) value; Use FG0, FG1, etc.
GOn—Go immediately to a specified state line n
LDn—LED indicator on a CU or SE case, LDn=1 turns ON the LED; LDn=0 turns it OFF
LTn—Light sensor n value (higher values indicate higher light levels)
NMn—“Not-for-Me” button value in the control unit (1 if the button is pressed)
PAn—Plays audio track n. Stops a PS track but waits for another PA track to complete
PSn—Plays audio track n. Immediately stops any other track before playing.
PXn—Immediately stops playing the current audio track
PIn—PIR sensor n value (1 when a person is detected)
SEn—SEn=1 to start sending the weight from SE n to the CU. SEn=0 stops transmission
TD—Time of day, HH:MM, 24 hour time
TMn—Timers, n is the timer number
VCn—Volume Control for CU playback, audio channel n

Examples of Syntactical Components:

| | CC | N | O | V | VS | I | G |
|---|---|---|---|---|---|---|---|
| PA5 | PA | 5 | “” | “” | “” | “” | “” |

Plays audio track 5

| | | | | | | | |
|---|---|---|---|---|---|---|---|
| FG0=1 | FG | 0 | = | 1 | “” | “” | “” |

Set flag 0 to the value
1

| | | | | | | | |
|---|---|---|---|---|---|---|---|
| FG0>2_5 | FG | 0 | > | 2 | “” | “” | 5 |

If flag 0 is greater than 2 then execute sequence line 5 next

| | | | | | | | |
|---|---|---|---|---|---|---|---|
| FG0=+1 | FG | 0 | = | +1 | “” | “” | “” |

Increment flag 0 by 1

| | | | | | | | |
|---|---|---|---|---|---|---|---|
| BR1>5_E7 | BR | 1 | > | 5 | “” | E | 7 |

When the weight value from load cell BR1 is greater than 5 then
execute sequence line 7 next.
Arm this command as an interrupt rather than execute it once in the
sequence line.

| | | | | | | | |
|---|---|---|---|---|---|---|---|
| DP0=“207test” | DP | 0 | = | “” | “207test” | “” | “” |

On display 0, display the string <test> on line 2 starting at
character 7

### Detailed Command Descriptions

BRn
Brush sensor weight value in grams. This is the weight on the load cell number n.
This command cannot be set to a value.

DCn
Data Collection; Use DC0, DC1, etc. to mark events.
When a DCn is executed, information about the running state of the sequence is saved in memory. When each DCn is executed, the time accumulated by the preceding DCn is stored along with the associated index n and the date and time. The indices n can be any identifying set of numbers.
Entering state 1 terminates any running data collection timer and saves the time.
When the sequence is first started, the data collection file is initiated with a first entry of:
   Date, Time, Software revision number, Sequence identification
The sequence identification is the contents of the first line of the sequence.
Each subsequent entry is in the form:
   Date, Time, DCn, Start state, End state, Counted time in seconds
The data file is stored in nonvolatile memory and is appended to each time the sequence is manually started. In some embodiments, the file may be uploaded to a PC or deleted (reset) by manual control or a remote command from a caregiver.

DEn
Data Entry from a keypad or serial port
DEn=V where:
   n is 0 to get a value from a keypad associated with a display
      Flag V is set to the value entered when an Enter key is pressed
   n is 1 to get a value from a serial port
      Flag V is set to the value of a numeric string terminated by a carriage return
   V is the number of a Flag register to store the value when the entry is complete.

DM
Demo Mode value set by user input (for example, by means of a keypad and display)
The value is 1 if in Demo Mode, else 0
Tested to determine if the sequence should change to accommodate the needs of a demonstration, user/caregiver training or sequence testing
For example:
   DM=1_{—}8 If in Demo mode, then go to state 8

DPn
Display a string of characters on an internal display such as an LCD or serial port DPn=>lccstring where:
   > indicates a string follows that will be interpreted based on the value of n
   n is 0 to LCD or 1 to serial port
   1 is the display line
   cc is the starting character position on the display line
   string is the character string to display (lcc are not used if n=1)

| | |
|---|---|
| DP0=>112Coaching | writes the string “Coaching” to the display |
| | line 1, starting at character 12 |
| DP1=>Hello | sends the string “Hello” to a serial port |
| DP9=0 | clears the display screen |
| DP9=1 | returns the display to its content prior to any DP |
| | commands |

Example sequence:
“1, VC0=15, PA13, DP9=0, GO2”
“2, DP0=>102 This is a test, DP0=>202 Press<to return, GO3”
“3, DP1=>Text sent to serial port, GO4”
“4, GO4”

IE=1
IE=1 Enables all armed CU interrupts (allows any armed interrupt that tests true to cause a branch)
IE=0 Disables all armed CU interrupts without disarming any (no interrupt can cause a branch)
Used to stop any other interrupt from interfering with a set of commands initiated by one interrupt.
Any interrupt that causes a branch disables all interrupts (as if an IE=0 was executed)
Typically, the branch will cause execution of one or more commands in one or more states before an IE=1 command is executed, allowing other interrupts to cause a branch.

FGn
Flag value such as FG0, FG1, etc.
Flag can be set to a value, incremented, decremented or tested.
All timers and flags are reset to 0 when state 1 is entered.
A flag may also be set to a value by the Data Entry command, DEn.
Examples:
FGn=3 sets FGn to 3
FGn=+2 increments FGn by 2
FGn=−1 decrements FGn by 1
FG1>3_{—}5 when the value of FG1 is greater than 3 then execute state 5 next

GOn
Begin execution of state n next
A GO command is not required to exit a state if no loops are running.
If all commands in a state are completed with no explicit GO command or a branch due to a test, then the next sequential state is entered.

LDn
Control a discrete LED on the CU or SE case:
   LDn=1 turns ON the LED on the CU or SE designated by n
   LDn=0 turns OFF the LED on the CU or SE designated by n

LTn
Light sensor value
Lower values indicate LOWER light levels.
   For example:
      LT1>25_{—}10 If the value of the light sensor is greater than 25, then go to state 10

NM
“Not-for-Me” value
1 if the button or other discrete sensor input is true.
The value is cleared to 0 after the value is tested so that the input must go false before it will be recognized as true again.

PAn
Play audio track
Starts playing an audio track designated by the index. A PA command will not start playing until a previously playing audio track stops that was started by another PA command. Will immediately stop a PS-initiated track and start playing track n. Consequently, the system stops interpreting subsequent commands (hangs up) while waiting for the previous PA to finish. The system starts again when the second PA starts playing. In contrast, the PS command immediately stops playing any previous audio track and then plays the designated track.
For example:
   “2, PA15, PA10”
      Line 2 first play track 15. The system stops interpreting commands until track 15 finishes playing and track 10 starts playing.
   “3, PS16, TM0=0, NM1=1_{—}4, (TM0>5_{—}3)”
      Line 3 and track 16 will repeat every 5 seconds until the Not-for-Me button is pressed
      If track 16 has a playing time longer than 5 seconds, then it will not finish playing before restarting.
Audio tracks within a state play in order, continuing to completion while any loop in that state runs.
The syntax PAn=V_G provides a test to determine if any audio track is currently playing.
This command causes the sequence to go to line G if track n is not playing and V is 1. The sequence will not go to G if the track is still playing and V=1.
Examples of audio tracks (as utilized by the example sequence in the next section)
PA1: “Good morning Mom”
PA2: “Good evening Mom”
PA3: “I need you to brush your teeth now”
PA4: “Please take your toothbrush from the holder”
PA5: “Mom, please take your toothbrush from the holder”
PA6: “Thank you. Now I need you to put some toothpaste on the brush”

PSn
Play an audio track
If any track is playing it stops immediately before playing the designated track.
PA- and PS-designated audio tracks will continue to play while subsequent commands are being executed on the same statement line as the PA or PS command.
PA- and PS-designated tracks will also continue to play when the system goes to a different statement line and continues to execute commands on that statement line and subsequent statement lines.

PXn
Immediately stops playing the current audio track.
For example, PX0 stops any track that is playing.
PXn will stop track n if it is currently playing.
The following commands, in line 3, allows a playing audio track to be quickly stopped by an interrupt. See comments in line 3
“1, NM1=1_E3, GO2” arms the Not-for-Me interrupt
“2, GO2” system stays here until the Not-for-Me button is pushed
“3, PX0, PA6, (PA6=1_{—}4)” PX0 stops any track playing; PA6 plays;
   While the track plays (PA6=1_{—}4) is a loop constantly checking for the track to finish. While this loop is running, the system poles the interrupts. When the track stops playing, the system goes to line 4. This sequence works around the problem of interrupts not being poled when a PA command is used.
“4, PX0, PA7, GO2”

PIn
PIR (Passive Infrared) sensor value
Returns a value of 1 when a person is detected by PIR sensor n.

SEn
Controls the designated SE
Set to 0 to stop SEn from sending data, e.g., from sampling weight; Set to 1 to start sampling
The syntax SEn=V can cause the designated SE to enter various modes such as low power or continuous sampling.

TD
Time of day
Return the time of day in hours and minutes in 24-hour time.
The time may be compared to a set time, for example:
TD>HH:MM_G Goes to state G if the current time is equal to HH:MM
In this example, MM is optional.

TMn
Timer values
The timer designated by index n may be set to a value in seconds or tested.
Multiple timers may be running at once. All timers count up from the value last set in seconds.
The maximum value a timer will count to is 65535 seconds.
All timers that are initialized increment once per second until either they are reinitialized or reset upon entering state 1.
All timers and flags are reset to 0 when state 1 is entered.
For example:
TM1=0 Resets timer 1 to 0 seconds
TM2>5_{—}7 Tests timer 2; If timer 2 has counted to more than 5 seconds, then go to state 7.

VCn
Volume control
Sets the audio output volume of the amplifier in the designated device.
May be set to values of 0-63, where higher numbers result in higher volume.
For example:
VC0=30 Sets the volume of the CU amplifier to 30
VC4=45 Sets the volume of remote device 4's amplifier to 45.

Interrupts
Syntax: CCn<V_[E|D]G
“E” arms the associated command for execution if interrupts are enabled.
An interrupt command remains armed and maintains the same values, (i.e., comparison value and go state) until:
   it is disarmed, see below.
   it is replaced with the same command with different values
“D” disarms an interrupt.
V can be any value, it does not have to be the same value used when the interrupt was armed
G is optional
Any testable command may be designated as an interrupt.

While the preceding commands and functions may be used in one embodiment of a Sequence Description Language, those skilled in the relevant art would recognize the ability to utilize additional or different commands or express an SDL in a different syntax or representation. For example, a sequence may be expressed by a graphical representation or by entries in a spreadsheet. In some embodiments, an SDL similar to that described above may serve as an intermediate language, compiled from the graphical or spreadsheet representation and then loaded onto and executed by an AA CU interpretively or after compilation to machine code.

Toothbrushing Sequence Example

In some embodiments, an AAT may be controlled by a sequence written using a Sequence Description Language to coach a user through the activity of tooth brushing. One exemplary embodiment of such a sequence to control an AAT is listed below. This is an illustration of an exemplary sequence written in a Sequence Description Language according to one embodiment of the present invention. This sequence is similar to that shown in the flowcharts describing the operation of the systems depicted in FIGS. 10A, 10B and 10C.

In the sequence listed below, the system waits for initial conditions to be simultaneously true: the room light ON, a person approaching the unit, the time of day within one of two reminder periods, and the toothbrush in the holder. If all these conditions occur at the same time, the system coaches the user through the activity of tooth brushing. In this embodiment, the sequence includes playing music before any verbal instruction. The system greets the user, and asks the user to take the toothbrush from the holder. If the user removes the brush from the holder, the system coaches the user to put toothpaste on the brush and then to brush. When enough time has elapsed, the system coaches the user to put the brush back in the holder. If the user does this, the system thanks the user and plays a pleasant music track as a reward. The system then goes back to wait for the initial conditions to be simultaneously true to start the coaching activity in the next applicable period.

During the toothbrushing coaching process, if the user does not remove the toothbrush from the holder or put it back after one request, then the system will repeat multiple requests. If the user does not comply after a specified number of requests, the system displays “No Response” on the CU display and goes back to wait for the initial conditions to be simultaneously true.

If the user successfully completes the activity of toothbrushing, and then removes the toothbrush before the next reminder period, the system will coach the user that he or she has already brushed. This is a demonstration of how the system is aware of the situation and gives an appropriate response.

In some embodiments, the system does not automatically differentiate between the intended user and another person. Accordingly, someone who is not the intended user can stop the coaching sequence by pushing the Not-for-Me button, when it is activated. This would delay the system from waiting for initial conditions to be simultaneously true to start the coaching sequence again.

In some embodiments, the AAT does not determine what the user does with the toothbrush. This configuration of an AAT is compatible with a user who should be able to follow the coaching instructions. For example, when the AAT coaches the user to brush his or her teeth, the user actually does this activity.

Another embodiment might have an accelerometer and associated circuitry attached to the toothbrush, which would transmit the motion of the toothbrush to the SE or CU. The system might then infer that motion of the toothbrush indicates that the user is picking up or putting down the brush, applying the toothpaste and brushing his or her teeth.

Some embodiments of the AAT measure change of weight to infer that the toothbrush was removed or put back in the holder. The AAT could also distinguish if other objects, such as a toothpaste tube or a smaller brush were removed from or put in the holder by differences in weight. These differences could be established by sequence programming or, during initial setup, by caregiver interaction with the CU or SE, for example, where each object is placed into the holder when the CU or SE requests it.

In the sequence below, the terms state, sequence line, and line are used interchangeably. One state consists of a line of text with one or more commands that determine events that may perform certain functions while in the state and may cause the state to exit.

Toothbrushing Sequence, Version 1.0
1, SE=1, VC0=30, GO2
2, NM1=1_{—}3, DP9=1, GO3
3, P11=1_{—}4, GO3
4, LT1>20_{—}5, GO3
5, TD1<0800_{—}3, GO6
6, TD1>1000_{—}8, FG1=0_{—}7, FG1=1_{—}7, GO3
7, FG2=1, BR1<5_{—}11, GO15
8, TD1<2000_{—}3, GO9
9, TD1>2200_{—}3, FG1=0_{—}10, FG1=2_{—}10, GO3
10, FG2=2, BR1<5_{—}11, GO15
11, BR1>5_E15, IE=1, DC1, FG3=0, GO12
12, FG3=3_{—}64, GO13
13, PS10, (PA1=1_{—}14)
14, PS19, FG3=+1, TM1=0, (TM1>6_{—}12)
15, BR1<5_E25, NM1=1_E62, IE=1, PS13, DC2, GO16
16, DP9=0, DP0=>201 Press Top Button To, DP0=>303 Stop Coaching, (PA1=1_{—}17)
17, FG2=2_{—}18, PS1, (PA1=1_{—}19)
18, PS2, (PA1=1_{—}9)
19, PS3, (PA1=1_{—}20)
20, PS19, TM1=0, (TM1>5_{—}21)
21, NM1=1_D1, DP9=0, DP0=>207 Coaching, GO22
22, PS4, FG3=0, DC3, TM1=0, (TM1>4_{—}23)
23, FG3=2_{—}64, GO24
24, PS5, FG3=+1, TM1=0, (TM1>4_{—}23)
25, BR1>5_E21, IE=1, DC4, GO26
26, PS6, (PA1=127)
27, PS19, TM1=0, (TM1>10_{—}28
28, FG3=0, FG5=0, GO29
29, BR1>5_E34, IE=1, DC5, FG5=+1, FG5>3_{—}64, GO30
30, PS7, TM1=0, (PA1=131)
31, PS19, (TM1>15_{—}32)
32, FG3=5_{—}39, TM1=0, PS8, (PA1=1_{—}33)
33, PS19, FG3=+1, (TM1>15_{—}32)
34, BR1<5_E29, IE=1, DC6, PS16, (PA1=1_{—}35)
35, FG4=0, GO36
36, FG4=3_{—}64, GO37
37, TM1=0, PS4, FG3=+1, (PA1=1_{—}38)
38, PS19, (TM1>7_{—}36)
39, BR1>5_E44, IE=1, DC7, PS9, (PA1=140)
40, FG3=0, GO41
41, FG3=3_{—}64, GO42
42, TM1=0, PS10, (PA1=1_{—}43)
43, PS19, FG3=+1, (TM1>7_{—}41)
44, BR1<5_E50, IE=1, DC8, PS11, (PA1=1_{—}45)
45, PS20, (PA1=1_{—}46)
46, FG1=1_{—}48, FG1=2_{—}49, FG1=0_{—}47, GO1
47, FG2=1_{—}48, GO49
48, FG1=2, GO2
49, FG1=1, GO2
50, BR1>5_E61, IE=1, DC9, GO51
51, PS18, TM1=0, (TM1>6_{—}52)
52, FG1=2_{—}53, FG1=1_{—}54, GO1
53, PS12, (PA1=1_{—}55)
54, PS13, (PA1=1_{—}55)
55, PS14, TM1=0, (PA1=1_{—}56)
56, PS19, (TM1>10_{—}57)
57, FG3=0, GO58
58, FG3=2_{—}61, GO59
59, PS10, TM1=0, FG3=+1, (PA1=1_{—}60)
60, PS19, TM1=0, (TM1>10_{—}58)
61, PS15, DC10, (PA1=1_{—}2)
62, PS1, DP9=0, DP0>205 OK I'll try again, DP0=>308 in a while, (PA1=1_{—}63)
63, DC11, TM1=0, (TM1>300_{—}2)
64, PS20, IE=1, DC12, DP9=0, DP0=>2057 No Response, GO65
65, TM1=0, (TM1>8_{—}2)

Detailed Explanation of the Toothbrushing Sequence, Version 1.0
Flags

| | | |
|---|---|---|
| FG | 1 | =0 on power up or executing line 1, If = 1 then morning is |
| | | the next coaching period; if = 2 then evening is the next |
| | | coaching period |
| FG | 2 | if = 1: current time is within the morning time period |
| | | interval; =2: current time is within the evening time period |
| | | interval |
| FG | 3 | Counts the number of times an audio track is played. |
| FG | 4 | Counts the number of times an audio track is played. |
| FG | 5 | Counts the number of times the toothbrushing sequence is |
| | | repeated staring in line 29 |

Timers

| | | |
|---|---|---|
| TM | 1 | Used to time an audio track play duration, starting when |
| | | an audio track starts to play |
| TM | 2 | Used to time the interval during which the system refrains |
| | | from testing, if the criteria have been met, to start the |
| | | coaching sequence again. |

Data Collection

| | |
|---|---|
| DC | Data Collection; Use DC0, DC1, etc. to mark events |

Audio Tracks

| | |
|---|---|
| 1 | “Good morning Mom” |
| 2 | “Good evening Mom” |
| 3 | “I need you to brush your teeth now” |
| 4 | “Please take your toothbrush from the holder” |
| 5 | “Mom, please take your toothbrush from the holder” |
| 6 | “Thank you. Now, I need you to put some toothpaste on the |
| | brush” |
| 7 | “OK, I'm going to wait while you brush” |
| 8 | “Please keep brushing” |
| 9 | “OK, you have brushed enough” |
| 10 | “Now, I need you to put the toothbrush back in the holder” |
| 11 | “OK Mom, thanks for brushing” |
| 12 | “Mom, you already brushed your teeth this morning” |
| 13 | “Mom, you already brushed your teeth this evening” |
| 14 | “Please put the brush back in the holder” |
| 15 | “Thank you for putting the toothbrush back” |
| 16 | “Mom. You have not brushed long enough” |
| 17 | “Ok. I'll try again in a while” |
| 18 | Initial music |
| 19 | Continue brushing music |
| 20 | Ending music |
| 21 | Beep |

The first line initializes the system by turning on the remote SE to start transmitting the weight on the load cell. A container attached to the load cell can hold the toothbrush. The container is called the holder.

The audio volume is set in the CU.

When sequence line 1 is executed, all flags and timers are reset to 0.

Line 1 is 1, SE=1, VC0=30, GO2. SE=1 is the command: Turn on the remote SE with a load cell to start transmitting the weight. VC0=30 is the command: Set the audio volume to 30 out of 63. GO2 is the command: Go to line 2 [When sequence line 1 is executed, all flags and timers are reset to 0].

The system returns to line 2 after: completing the toothbrushing coaching sequence, returning the brush after it was removed at an inappropriate time, the Not-for-Me button was pressed, or No Response.

The following clears the NM command value. It might have been set to 1 if the button was pressed while executing the sequences below and if the NM command was not tested. Testing the NM command clears the value that indicated the button was pressed.

Line 2 is 2, DP9=1, NM1=1_{—}3, GO3. DP9=1 is the command: Returns the display to display the time and date. NM1=1_{—}3 is the command: Test the Not-for-Me button: when the button is pressed GO3, [Testing the NM command clears a value indicating that the button was pressed], [Before returning to this line, it is possible that the button was pressed and after it was pressed, there was not a test NM command. Testing the NM command clears a value indicating that the button was pressed. By clearing this value, arming the NM interrupt on line 15 will not incorrectly detect that the button was pressed]. GO3 is the command: Else, go to line 3.

The toothbrushing coaching sequence starts when the appropriate criteria are true in sequence lines 3 to 10.

The system continues to cycle through these tests until the appropriate criteria are true.

If the system coached through a complete toothbrushing coaching sequence before returning to line 2, then the brush interrupt was armed in line 44 to go to line 50 when the holder detects the weight of the brush is removed.

If the brush is removed from the holder and the following criteria are not met, then the brush was removed at an inappropriate time. The user is coached to place the toothbrush in the holder. The system reminds the user that he or she already brushed in the last time period.

Line 3 is 3, P11=1_{—}4, GO3 PI1=1_{—}4 is the command: Test the Passive Infrared sensor (PIR): When it detects the presence of someone then go to line 4. GO3 is the command: Else, go to line 3 [Start over checking all criteria.]

Line 4 is 4, LT1>20_{—}5, GO3. LT1>20_{—}5 is the command: Test light sensor: if >20 then go to line 5 [Room light brightness, higher numbers are brighter]. GO3 is the command: Else, go to line 3. [Start over checking all criteria].

The next 2 lines check if the current time is in the morning time period.

Line 5 is 5, TD1<0800_{—}3, GO6. TD1<0800_{—}3 is the command: If the current time is less then 8 AM then [not the morning time period] go to line 3 [Start over checking all criteria]. GO6 is the command: Else, go to line 6.

Line 6 is 6, TD1>1000_{—}8, FG1=0_{—}7, FG1=1_{—}7, GO3. TD1>1000_{—}8 is the command: If the current time >then 10 AM then [not the morning time period] go to line 8, else [Then must be in morning time period]. FG1=0_{—}7 is the command: Test flag 1: when=0 then go to line 7 [Test flag 1=0 when the system is powered up. This test causes the system to coach the user during the current time period]. FG1=1_{—}7 is the command: Test flag 1: when=1 then go to line 7 [Test flag 1=1 when the morning time period is the next time period to coach]. GO3 is the command: Else, go to line 3 [Then flag 1 must be 2 meaning the user already brushed in this time period. The next brushing time period is the evening time period. Therefore start over checking all criteria].

Line 7 is 7, FG2=1, BR1<5_{—}11, GO15. FG2=1 is the command: Set FG2=1 [To start coaching in the morning time period]. BR1<5_{—}11 is the command: Test the weight in the brush holder: if <5 then go to line 11, [brush not in the holder]. GO15 is the command: Else, go to line 15 [Go to the toothbrushing coaching sequence].

The next 2 lines check if the current time is in the evening time period.

Line 8 is 8, TD1<2000_{—}3, GO9. TD1<2000_{—}3 is the command: If the current time is less then 8 PM then [not the evening time period] go to line 3, [Start over checking all criteria]. GO9 is the command: Else, go to line 9.

Line 9 is 9, TD1>2200_{—}3, FG1=0_{—}10, FG1=2_{—}10, GO3. TD1>2200_{—}3 is the command: If the current time >then 10 PM then [not the evening time period] go to line 3, else [must be in evening time period]. FG1=0_{—}10 is the command: Test flag 1: when=0 then go to line 10 [Test flag 1=0 when the system is powered up. This test causes the system to coach the user during the current time period]. FG1=2_{—}10 is the command: Test flag 1: when=2 then go to line 10 [Test flag 1=2 when the evening time period is the next time period to coach]. GO3 is the command: Else, go to line 3 [Then flag 1 must be 1 meaning the user already brushed in this time period. The next brushing time period is the morning time period. Therefore start over checking all criteria].

Line 10 is 10, FG2=2, BR1<5_{—}11, GO15. FG2=2 is the command: Set FG2=2 [To start coaching in the evening time period]. BR1<5_{—}11 is the command: test the weight in the brush holder: if <5 then go to line 11, [brush not in the holder]. GO15 is the command: Else, go to line [Go to the toothbrushing coaching sequence].

The system arrives at line 11 if the holder did not detect the brush weight before starting the coaching sequence.

The following lines coach the user to put the toothbrush back in the holder. First, an interrupt is armed to detect when the weight of the brush is present the holder. If the holder detects the weight of the brush, then the toothbrushing coaching continues. If the holder does not detect the brush weight after 3 requests to put the toothbrush back, the system goes to line 64, No Response.

Line 11 is 11, BR1>5_E15, IE=1, DC1, FG3=0, GO12. BR1>5_E15 is the command: Arm the brush interrupt to test the weight in the brush holder: if >5 then go to line 15, [when the weight of the brush is detected in the holder start the toothbrush coaching sequence]. IE=1 is the command: Enable the interrupts. DC1 is the command: Data Collection 1 to mark that the holder did not detect brush weight at the beginning of the toothbrushing coaching sequence. FG3=0 is the command: Set FG3=0 [This flag is used to count the number of times the audio track repeats in the next two lines]. GO12 is the command: Go to line 12.

Line 12 is 12, FG3=3_{—}64, GO13. FG3=3_{—}64 is the command: Test flag 3: when=3 then go to line 64 [If the brush not put back into the holder after playing the audio tracks 3 times then go to line 64 ‘No Response’ ]. GO13 is the command: Go to line 13 [By testing Flag 3 on this line, instead of the next line, Timer 1 is allowed to time out before doing this flag test. This allows track PS19, the continuation music, in line 14, to play the prescribed time interval before doing the flag text on this line].

Line 13 is 13, PS10, (PA1=1_{—}14). PS10 is the command: Plays audio track 10: “Now, I need you to put the toothbrush back in the holder.” (PA1=1_{—}4) is the command: In a loop, repeatedly test: when the audio track has ended go to line 14.

Line 14 is 14, PS19, FG3=+1, TM1=0, (TM1>6_{—}12). PS19 is the command: Plays audio track 19: Continue brushing music. FG3=+1 is the command: increment Flag 3 by +1. TM1=0 is the command: Set timer 1=0. (TM1>6_{—}12) is the command: In loop, repeatedly test: when timer 1>6 seconds then go to line 12 [Timer 1 stops the continuing music track playing after 6 seconds have elapsed].

The system arrives at line 15 if user's presence is detected, light sensor detects light, current time is in a brushing time period, the user did not already brush during this time period, and the holder detects the weight of the brush.

The following is the start of the toothbrush coaching sequence.

Line 15 is 15, BR1<5_E25, NM1=1_E62, IE=1, PS13, DC2, GO16. BR1<5_E25 is the command: Arm the brush interrupt to test the weight in the brush holder: if <5 then go to line 25, [When the brush is removed from the holder go to line 25] [This interrupt causes the system to immediately go to the line responding to the brush being removed from the holder. Doing this passes over all the sequence lines requesting the user remove the brush. This demonstrates the concept of situational awareness (the is brush picked up) to give an appropriate response (coach to put toothpaste on the toothbrush)]. NM1=1_E62 is the command: Arm the Not-for-Me button interrupt: when the button is pressed go to line 62 [The system cannot differentiate between the intended user or another person. Someone who is not the intended user, could stop the coaching sequence by pressing the Not-for-Me button. Also, this would delay the system from starting to test, if the criteria have been met, to start the coaching sequence again]. IE=1 is the command: Enable the interrupts. PS13 is the command: Plays audio track 13: Initial music. DC2 is the command: Data Collection 2 to mark the start of the toothbrushing coaching sequence. GO16 is the command: Go to line 16.

Line 16 is 16, DP9=0, DP0=>201 Press Top Button To, DP0=>303 Stop Coaching, (PA1=1_{—}17). DP9=0 is the command: Clear the display. DP0=>201 PressTopButtonTo is the command: Display on line 2, starting at character 1: “Press Top Button To.” DP0=>303 StopCoaching is the command: Display on line 3, starting at character 3: “Stop Coaching.” (PA1=1_{—}17) is the command: In a loop, repeatedly test: when the audio track (started in line 15) has ended go to line 17.

After the initial music ends, starting at line 17, the system greets the user and then asks the user to take the brush.

Line 17 is 17, FG2=2_{—}18, PS1, (PA1=1_{—}19). FG2=2_{—}18 is the command: Test flag 2, if=2 then [in the evening time period] go to line 18, else [must be in the morning time period]. PS1 is the command: Plays audio track 1: ‘Good morning Mom.’ (PA1=1_{—}19) is the command: In a loop, repeatedly test: when the audio track has ended go to line 19.

Line 18 is 18, PS2, (PA1=1_{—}9). PS2 is the command: Plays audio track 2: “Good evening Mom.” (PA1=1_{—}19) is the command: In a loop, repeatedly test: when the audio track has ended go to line 19.

Line 19 is 19, PS3, (PA1=1_{—}20). PS3 is the command: Plays audio track 3: “I need you to brush your teeth now.” (PA1=1_{—}20) is the command: In a loop, repeatedly test: when the audio track has ended go to line 20.

Line 20 is 20, PS19, TM1=0, (TM1>5_{—}21). PS19 is the command: Plays audio track 19: Continue brushing music. TM1=0 is the command: Set timer 1=0. (TM1>5_{—}21) is the command: In loop, repeatedly test: when timer 1>5 seconds then go to line 21 [Timer 1 stops the continuing music track playing after 5 seconds have elapsed].

The next lines ask the user to take the toothbrush from the holder. The first request starts with “Please . . . ”. The next request is more emphatic and starts with “Mom, please . . . ”. This repeats 2 times. If the brush is not picked up during the three requests then the system goes to line 64 ‘No Response’. If the brush is picked up during the 3 requests then the brush interrupt armed in line 15 causes the system to go to line 25.

The Not-for-Me button interrupt is disarmed; consequently, pressing it will not stop the coaching sequence. The display is changed to “Coaching”.

Line 21 is 21, NM1=1_D1, DP9=0, DP0=>207 Coaching, GO22. NM1=1_D1 is the command: Disarm the Not-for-Me button interrupt, [note: optional to have any value after “D”]. DP9=0 is the command: Clear the display. DP0=>207 Coaching is the command: Display on line 2, starting at character 7: “Coaching.” GO22 is the command: Go to line 22 [By disarming the Not-for-Me Button interrupt, pressing the button will no longer cause the system to stop the coaching sequence. Also, the display changes from “Press Top Button To Stop Coaching” to “Coaching”].

Line 22 is 22, PS4, FG3=0, DC3, TM1=0, (TM1>4_{—}23). PS4 is the command: Plays audio track 4: “Please take your toothbrush from the holder.” FG3=0 is the command: Set FG3=0 [This flag is used to count the number of times the audio track repeats in the next two lines]. DC3 is the command: Data Collection 3 to mark asking the user to take the brush at the start of the toothbrushing coaching sequence. TM1=0 is the command: Set timer 1=0. (TM1>4_{—}23) is the command: In loop, repeatedly test: when timer 1>4 seconds then go to line 23 [Timer 1 stops the continuing music track playing after 4 seconds have elapsed] [This timer is set for a longer time period then the time period of audio track 4. This results in silence after audio track 4 stops playing and before the next audio track starts to play in line 24].

Line 23 is 23, FG3=2_{—}64, GO24. FG3=2_{—}64 is the command: Test flag 3: when=2 then go to line 64 [If the weight of the brush is not detected in the holder after playing the audio tracks 2 times then go to “No Response”]. GO24 is the command: Go to line 24 [Testing Flag 3 on this line, instead of the next line, allows the test to happen after timer 1 times out. Timer 1 is in the next line].

Line 24 is 24, PS5, FG3=+1, TM1=0, (TM1>4_{—}23). PS5 is the command: Plays audio track 5: “Mom, please take your toothbrush from the holder.” FG3=+1 is the command: increment Flag 3 by +1. TM1=0 is the command: Set timer 1=0. (TM1>4_{—}23) is the command: In loop, repeatedly test: when timer 1>4 seconds then go to line 23 [This timer is set for a longer time period then the time period of audio track 5. This results in silence after audio track 4 stops playing and before this audio track repeats again].

The system goes to line 25 after the brush interrupt detects that the brush was removed from the holder.

The system coaches the user to put toothpaste on the toothbrush.

Line 25 is 25, BR1>5_E21, IE=1, DC4, GO26. BR1>5_E21 is the command: Arm the brush interrupt to test the weight in the brush holder: if >5 then go to line 21, [If the user puts the brush in the holder before the end of the brushing time, then the system will coach the user to remove the brush]. IE=1 is the command: Enable the interrupts. DC4 is the command: Data collection 4 to mark that the brush was removed from the holder at the appropriate time in the coaching sequence. GO26 is the command: Go to line 26 [If the user puts the brush in the holder during the following 3 sequence lines, the system goes back to line 21 to ask the user to remove the brush from the holder].

Line 26 is 26, PS6, (PA1=1_{—}27). PS6 is the command: Plays audio track 6: “Thank you. Now, I need you to put some toothpaste on the brush.” (PA1=1_{—}27) is the command: In a loop, repeatedly test: when the audio track has ended go to line 27.

Line 27 is 27, PS19, TM1=0, (TM1>10_{—}28). PS19 is the command: Plays audio track 19: Continue brushing music. TM1=0 is the command: Set timer 1=0. (TM1>10_{—}28) is the command: In loop, repeatedly test: when timer 1>10 seconds then go to line 28 [Timer 1 stops the continuing music track playing after 10 seconds have elapsed].

Line 28 is 28, FG3=0, FG5=0, GO29. FG3=0 is the command: Set FG3=0 [This flag is used to count the number of times the audio and music tracks repeats in lines 32 and 33 to ask the user to continue brushing. By setting the flag on this line, if the user replaces the brush before 5 request to continue to brush, and then if the user removes the brush from the holder, the system will just request the user continues to brush the remaining number of times]. FG5=0 is the command: Set FG5=0 [Counts the number of times the toothbrushing sequence is restarted in line 29. The system will go to ‘No Response’ if the user puts back and picks up the toothbrush more then 3 times when coached to ‘Please keep brushing’. This limits the amount of times the user can put back and pick up the toothbrush]. GO29 is the command: Go to line 29.

Line 29 is 29, BR1>5_E34, IE=1, DC5, FG5=+1, FG5>3_{—}64, GO30. BR1>5_E34 is the command: Arm the brush interrupt to test the weight in the brush holder: if >5 then go to line 34, [If the user puts the brush in the holder before the end of the brushing time, the system will coach the user to remove the brush. The user was instructed to put toothpaste on the toothbrush in line 13. At this point in the sequence, the user should have put toothpaste on the toothbrush. If the user puts the brush back in the holder before the end of the brushing time, and then takes the brush from the holder, the system will now start at line 29, coaching the user to brush and to keep brushing]. IE=1 is the command: Enable the interrupts. DC5 is the command: Data Collection 5 to mark the start of the sequence coaching the user to brush his or her teeth. FG5=+1 is the command: Increment Flag 5 by +1. FG5>3_{—}64 is the command: Test flag 5: when >3 then go to line 64 [No Response, see line 28 for an explanation of this test], else, GO30. GO30 is the command: Go to line 30.

Line 30 is 30, PS7, TM1=0, (PA1=1_{—}31). PS7 is the command: Plays audio track 7: “OK, I'm going to wait while you brush.” TM1=0 is the command: Set timer 1=0, [Timer 1 will time the total elapse time of playing the audio track, in this line, and music track, on line 31]. (PA1=1_{—}31) is the command: In a loop, repeatedly test: when the audio track has ended go to line 31.

Line 31 is 31, PS19, (TM1>15_{—}32). PS19 is the command: Plays audio track 19: Continue brushing music. (TM1>15_{—}32) is the command: In loop, repeatedly test: when timer 1>15 seconds then go to line 32 [Timer 1 times out after the audio track in line 30 and the continuing music track play a total of 15 seconds].

During the brushing time, the system coaches the user to continue to brush.

The CU plays “Please keep brushing” followed by music. This is repeated 5 times every 15 seconds, unless the holder detects the weight of the toothbrush, inferring that it was put back in the holder.

Line 32 is 32, FG3=5_{—}39, TM1=0, PS8, (PA1=1_{—}33). FG3=5_{—}39 is the command: Test flag 3: when=5 then go to line 39 [The user brushed long enough], else, TM1=0. TM1=0 is the command: Set timer 1=0, [Timer 1 will time the total elapse time of playing the audio track, in this line, and music track, on line 33]. PS8 is the command: Plays audio track 8: “Please keep brushing.” (PA1=1_{—}33) is the command: In a loop, repeatedly test: when the audio track has ended go to line 33 [Plays “Please keep brushing” followed by music. This is repeated 5 times].

Line 33 is 33, PS19, FG3=+1, (TM1>15_{—}32). PS19 is the command: Plays audio track 19: Continue brushing music. FG3=+1 is the command: Increment Flag 3 by +1. (TM1>15_{—}32) is the command: In loop, repeatedly test: when timer 1>15 seconds then go to line 32.

The system goes to line 34 if the user puts the brush on the holder before the end of the desired brushing time.

The following lines ask the user to take the brush from the holder. If the holder detects the weight of the brush was removed, then the toothbrushing coaching continues.

The value of flag 3, initialized in line 28, is not changed when going to the following lines, consequently if the user picks up the brush, the system will repeat asking the user to ‘Please keep brushing’ the remaining times until flag 3=5.

If the holder does not detect the brush weight was removed after 3 requests to take the brush, the system goes to line 64, No Response.

Line 34 is 34, BR1<5_E29, IE=1, DC6, PS16, (PA1=1_{—}35). BR1<5_E29 is the command: Arm the brush interrupt to test the weight in the brush holder: if <5 then go to line 29, [If the user removes the brush from the holder the system will return to coach the user to continue to brush his or her teeth]. IE=1 is the command: Enable the interrupts, DC6 is the command: Data Collection 6 to mark that the brush was put back in the holder before completing the toothbrush coaching sequence. PS16 is the command: Plays audio track 16: “Mom. You have not brushed long enough.” (PA1=1_{—}35) is the command: In a loop, repeatedly test: when the audio track has ended go to line 35.

Line 35 is 35, FG4=0, GO36. FG4=0 is the command: Set FG4=0 [This flag is used to count the number of times the audio tracks repeat in the following lines]. GO36 is the command: Else, go to line 36.

Line 36 is 36, FG4=3_{—}64, GO37. FG4=3_{—}64 is the command: Test flag 4: when=3 then go to line 64, [If the brush not removed from the holder after playing the following audio tracks 3 times then go to “No Response”]. GO37 is the command: Go to line 37 [Testing Flag 4 on this line, instead of the next line, allows the test to happen after timer 1 times out. Timer 1 is in the next line].

Line 37 is 37, TM1=0, PS4, FG3=+1, (PA1=1_{—}38). TM1=0 is the command: Set timer 1=0, [Timer 1 will time the total elapse time of playing the audio track, in this line, and music track, on line 38]. PS4 is the command: Plays audio track 4: “Please take your toothbrush from the holder.” FG3=+1 is the command: Increment Flag 3 by +1. (PA1=1_{—}38) is the command: In a loop, repeatedly test: when the audio track has ended go to line 38.

Line 38 is 38, PS19, (TM1>7_{—}36). PS19 is the command: Plays audio track 19: Continue brushing music. (TM1>7_{—}36) is the command: In loop, repeatedly test: when timer 1>7 seconds then go to line 36 [Timer 1 stops playing the continuing music track after 7 seconds have elapsed from the start of playing audio track 4 on line 37].

After the user has brushed long enough, the system coaches the user to return the brush to the holder.

First, the brush interrupt is armed and set to go to a different line when the weight of the brush is detected. If the holder detects the weight of the brush, then the toothbrushing coaching continues. If the holder does not detect the brush weight after 3 requests to put the toothbrush back, then the system goes to line 64, No Response.

Line 39 is 39, BR1>5_E44, IE=1, DC7, PS9, (PA1=1_{—}40). BR1>5_E44 is the command: Arm the brush interrupt to test the weight in the brush holder: if >5 then go to line 44, [The brush interrupt is change to go to line 44 when the weight of the brush is detected in the holder. Line 44 plays an audio track that thanks the user for brushing. Previous to this change, the brush interrupt would go to line 34 when the brush is detected in the holder, coaching the user to take the brush]. IE=1 is the command: Enable the interrupts. DC7 is the command: Data Collection 7 to mark that user was asked to return the brush to the holder after brushing their teeth. PS9 is the command: Plays audio track 9: “OK, you have brushed enough.” (PA1=1_{—}40) is the command: In a loop, repeatedly test: when the audio track has ended go to line 40.

Line 40 is 40, FG3=0, GO41. FG3=0 is the command: Set FG3=0 [This flag is used to count the number of times the audio track repeats in the next 3 lines]. GO41 is the command: Go to line 41.

Line 41 is 41, FG3=3_{—}64, GO42. FG3=3_{—}64 is the command: Test flag 3: when=3 then go to line 64 [If the brush is not put back into the holder after playing the audio tracks 3 times then go to line 64 ‘No Response’ ]. GO42 is the command: Go to line 42 [By testing Flag 3 on this line, instead of the next line, Timer 1 in line 43 is allowed to time out before doing this flag test. This allows audio track 10 in line 43 and audio track 10 in line 43 to play the total time interval of timer 1].

Line 42 is 42, TM1=0, PS10, (PA1=1_{—}43). TM1=0 is the command: Set timer 1=0, [Timer 1 times the combined duration of audio track audio track 10 in this line in this line and audio track 19 in line 43]. PS10 is the command: Plays audio track 10: “Now, I need you to put the toothbrush back in the holder.” (PA1=1_{—}43) is the command: In a loop, repeatedly test: when the audio track has ended go to line 43.

Line 43 is 43, PS19, FG3=+1, (TM1>7_{—}41). PS19 is the command: Plays audio track 19: Continue brushing music. FG3=+1 is the command: Increment Flag 3 by +1. (TM1>7_{—}41) is the command: In loop, repeatedly test: when timer 1>7 seconds then go to line 41 [Timer 1 times the combined duration of audio track 10 in line 42 and audio track 19 in this line. The total duration is set in this line].

The system goes to line 44 when the holder detects the weight of the brush.

The next lines thank the user for brushing, and then the system plays the ending music.

Line 44 is 44, BR1<5_E50, IE=1, DC8, PS11, (PA1=1_{—}45). BR1<5_E50 is the command: Arm the brush interrupt to test the weight in the brush holder: if <5 then go to line 50, [The brush interrupt is change to go to line 50 when the holder detects that the weight of the toothbrush is removed. Line 50 starts the sequence to tell the user that he or she already brushed and to return the brush to the holder]. IE=1 is the command: Enable the interrupts. DC8 is the command: Data Collection 8 to mark that holder detected the weight of the brush indicating the brush was returned after the user was coached to return the brush. PS11 is the command: Plays audio track 11: “OK Mom, thanks for brushing.” (PA1=1_{—}45) is the command: In a loop, repeatedly test: when the audio track has ended go to line 45.

Line 45 is 45, PS20, (PA1=1_{—}46). PS20 is the command: Plays audio track 20: Ending music. (PA1=1_{—}46) is the command: In a loop, repeatedly test: when the audio track has ended go to line 46.

To arrive at line 46 the user had to complete the toothbrushing coaching sequence. The following lines set flag 1.

If currently flag 1=1, then evening is the next coaching period; if flag 1=2, then morning is the next coaching period.

Line 46 is 46, FG1=1_{—}48, FG1=2_{—}49, FG1=0_{—}47, GO1. FG1=1_{—}48 is the command: Test flag 1: when=1 then go to line 48 [True=in morning time period], else, FG1=2_{—}49. FG1=2_{—}49 is the command: Test flag 1: when=2 then go to line 49 [True=in evening time period], else, FG1=0_{—}47. FG1=0_{—}47 is the command: Test flag 1: when=0 then go to line 47, [True=system just powered up, now must set flag 1 to the other current time period]. GO1 is the command: Else, go to line 1, [system get here if Flag 1 not set to 0, 1 or 2, this is an error. Going to line 1 reinitializes the system].

Line 47 is 47, FG2=1_{—}48, GO49. FG2=1_{—}48 is the command: Test flag 2: when=1 then go to line 48, else, [True=in morning time period]. GO49 is the command: Else, go to line 49, [Then flag 2 must=2 which means in the evening time period].

Line 48 is 48, FG1=2, GO2 49, FG1=1, GO2. FG1=2 is the command: Set flag 1 to 2, [this causes the system to test next for the evening time period]. GO2 is the command: Go to line 2 [Return to the beginning of the sequence to test for the next coaching session].

Line 49 is 49, FG1=1, GO2. FG1=1 is the command: Set flag 1 to 1, [this causes the system to test next for the morning time period]. GO2 is the command: Go to line 2 [Return to the beginning of the sequence to test for the next coaching session].

The system completed the toothbrushing coaching activity.

The system gets to line 50 if the holder detects the brush was removed and: the user already brushed during a time period, or it is in between brushing time periods.

The system coaches the user that he or she already brushed and to put the brush back in the holder.

If the brush is returned to the holder, the system goes to line 61, which thanks the user for returning the brush.

If the brush is not returned after 3 requests, then the system goes to line 64, ‘No Response.’

Line 50 is 50, BR1>5_E61, IE=1, DC9, GO51. BR1>5_E61 is the command: Arm the brush interrupt to test the weight in the brush holder: if >5 then go to line 61, [If the brush is returned to the holder go to line 61, which thanks the user for putting the brush back]. IE=1 is the command: Enable the interrupts. DC9 is the command: Data Collection 9 to mark that holder detected that the weight of the brush was removed at an inappropriate time: after already brushing in this time period or in between time periods. GO51 is the command: Go to line 51.

Line 51 is 51, PS18, TM1=0, (TM1>6_{—}52). PS18 is the command: Plays audio track 18: Initial music. TM1=0 is the command: Set timer 1=0. (TM1>6_{—}52) is the command: In loop, repeatedly test: when timer 1>6 seconds then go to line 52 [Timer 1 stops the continuing music track playing after 6 seconds have elapsed].

Line 52 is 52, FG1=2_{—}53, FG1=1_{—}54, GO1. FG1=2_{—}53 is the command: Test flag 1: when=2 then go to line 53, else, FG1=1_{—}54 [Flag 1 was set to 2 at the end of the morning coaching]. FG1=1_{—}54 is the command: Test flag 1: when=1 then go to line 54, else, G01 [Flag 1 was set to 1 at the end of the evening coaching]. GO1 is the command: Else, go to line 1, [system get here if Flag 1 was not set to 1 or 2, this is an error].

Line 53 is 53, PS12, (PA1=1_{—}55). PS12 is the command: Plays audio track 12: “Mom, you already brushed your teeth this morning.” (PA1=1_{—}55) is the command: In a loop, repeatedly test: when the audio track has ended go to line 55.

Line 54 is 54, PS13, (PA1=155). PS13 is the command: Plays audio track 13: “Mom, you already brushed your teeth this evening.” (PA1=1_{—}55) is the command: In a loop, repeatedly test: when the audio track has ended GO55.

The following lines ask the user to put the brush back.

Line 55 is 55, PS14, TM1=0, (PA1=1_{—}56). PS14 is the command: Plays audio track 14: “Please put the brush back in the holder”, [This audio track is play once]. TM1=0 is the command: Set timer 1=0, [Timer 1 will time the total elapse time of playing the audio track, in this line, and music track, on line 56]. (PA1=1_{—}56) is the command: In a loop, repeatedly test: when the audio track has ended go to line 56.

Line 56 is 56, PS19, (TM1>10_{—}57). PS19 is the command: Plays audio track 19: Continue brushing music. (TM1>10_{—}57) is the command: In loop, repeatedly test: when timer 1>10 seconds then go to line 57 [Timer 1 stops the continuing music track playing after 10 seconds have elapsed].

Line 57 is 57, FG3=0, GO58. FG3=0 is the command: Set FG3=0 [This flag is used to count the number of times the audio tracks repeat in the following lines]. GO58 is the command: Else, go to line 58.

Line 58 is 58, FG3=2_{—}61, GO59. FG3=2_{—}61 is the command: Test flag 3: when=2 then go to line 61, [If the brush was not put back into the holder after playing the following audio tracks 2 times then go to “No Response”. Testing Flag 3 on this line, instead of the next line, allows the test to happen after timer 1 times out. Timer 1 is in the next line]. GO59 is the command: Go to line 59.

Line 59 is 59, PS10, TM1=0, FG3=+1, (PA1=1_{—}60). PS10 is the command: Plays audio track 10: “Now, I need you to put the toothbrush back in the holder.” TM1=0 is the command: Set timer 1=0, [Timer 1 will time the total elapse time of playing the audio track, in this line, and music track, on line 60]. FG3=+1 is the command: Increment Flag 3 by +1. (PA1=1_{—}60) is the command: In a loop, repeatedly test: when the audio track has ended go to line 60.

Line 60 is 60, PS19, TM1=0, (TM1>10_{—}58). PS19 is the command: Plays audio track 19: Continue brushing music. TM1=0 is the command: Set timer 1=0. (TM1>10_{—}58) is the command: In loop, repeatedly test: when timer 1>10 seconds then go to line 58 [Timer 1 stops playing the continuing music track after 10 seconds have elapsed from the start of playing audio track 10 on line 59].

The system gets to line 61 when the holder detects the weight of the brush.

Line 61 is 61, PS15, DC10, (PA1=1_{—}2). PS15 is the command: Plays audio track 15: “Thank you for putting the toothbrush back.” DC10 is the command: Data Collection 10 to mark that the user returned the brush, after removing it at an inappropriate time. (PA1=1_{—}2) is the command: In a loop, repeatedly test: when the audio track has ended go to line 2.

The system goes to line 62 if the Not-for-Me button was pressed when the Not-for-Me interrupt was armed in line 15 to go to this line and interrupts were enabled.

This embodiment cannot automatically differentiate between the intended user and another person. Someone who is not the intended user can stop the coaching sequence by pressing the Not-for-Me button, when it is activated. Also, this delays, for 300 seconds, the system from testing if the criteria have been met to start the coaching sequence again.

Line 62 is 62, PS1, DP9=0, DP0=>205 OK I'll try again, DP0=>308 in a while, (PA1=1_{—}63). PS17 is the command: Plays audio track 17: “Ok. I'll try again in a while.” DP9=0 is the command: Clear the display. DP0=>205 OK I'll try again is the command: Display on line 2, starting at character 5: “OK I'll try again.” DP0=>308 in a while. is the command: Display on line 3, starting at character 8: ‘in a while.’ (PA1=1_{—}63) is the command: In a loop, repeatedly test: when the audio track has ended go to line 63.

Line 63 is 63, DC11, TM1=0, (TM1>300_{—}2). DC11 is the command: Data Collection 11 to mark that the Not-for-Me button was pressed when the Not-for-Me interrupt would go to this line and interrupts were enabled. TM1=0 is the command: Set timer 1=0. (TM1>300_{—}2) is the command: In loop, repeatedly test: when timer 1>300 seconds then go to line 2 [The display returns to display the time and date by executing command DP9=1 in line 2] [Note that in line 44 the brush interrupt was armed and is still enabled to detect if the brush is removed from the holder. If the brush is removed then this waiting period is terminated].

The system arrives at line 64 if the user did not respond to an instruction.

The display displays “No Response.”

Line 64 is 64, PS20, IE=1, DC12, DP9=0, DP0=>2057 No Response, GO65. PS20 is the command: Plays audio track 20: Ending music. IE=0 is the command: Disables all interrupts, [This prevent the system from going to a sequence line determined by an armed interrupt]. DC12 is the command: Data Collection 12 to mark that the user did not respond to an instruction. DP9=0 is the command: Clear the display. DP0=>2057 No Response is the command: Display on line, 2 starting at character 7: ‘No Response.’ GO65 is the command: Go to line 65.

Line 65 is 65, TM1=0, (TM1>8_{—}2). TM1=0 is the command: Set timer 1=0. (TM1>8_{—}2) is the command: In loop, repeatedly test: when timer 1>8 seconds then go to line 2, [The display returns to display the time and date by executing command DP9=1 in line 2].

That is the end of the sequence.

Although certain exemplary embodiments of the invention have been illustrated and described, one of ordinary skill in the art and technology to which the invention pertains would understand that several modifications and alterations to the described embodiments may be made without departing from the principal, spirit and scope of the present invention. For example, although the described embodiments are principally described as aids for the elderly or mentally impaired, it is understood that the described embodiments can be used as aids for anyone, whether impaired or not. Accordingly, the foregoing description should not be read as pertaining only to the precise embodiments described, but rather should be read consistent with and as support for the following claims, which are to have their fullest and fairest scope.

What is claimed is:

1. A system to provide instructional cues to a user, comprising:
a controller;
at least one memory for storing a plurality of instructional cues;
at least one proximity sensor for detecting proximity of the user; and
at least one compliance sensor for detecting compliance of the user with at least one instructional cue,
wherein the controller is in communication with the at least one proximity sensor and the at least one compliance sensor, such that during activation of the at least one proximity sensor the controller in response to the compliance sensor selects an instructional cue from the plurality of instructional cues to relay to the user.

2. The system according to claim 1, further comprising a clock for measuring time, wherein the controller is further in communication with the clock, and wherein the controller selects the instructional cue in response to the compliance sensor and the clock.

3. The system according to claim 1, further comprising an additional sensor selac et from the group consisting of object sensors for detecting interaction of the user with an object, environmental sensors for detecting environmental conditions, user action sensors for determining an action of the user, and combinations thereof, wherein the controller is further in communication with the additional sensor and wherein the controller selects the instructional cue in response to the compliance sensor and the additional sensor.

4. The system according to claim 1, further comprising an interface for communicating information about the user to a third party.

5. The system according to claim 1, further comprising a first interface for loading a program into the controller.

6. The system according to claim 5, further comprising a means for testing the program by simulating signals from the proximity sensor and the compliance sensor.

7. The system according to claim 5, further comprising a second interface for communicating information about the user to a third party.

8. The system according to claim 7, wherein the second interface comprises a network interface.

9. The system according to claim 1, wherein the at least one instructional cue instructs the user to refrain from performing a task.

10. The system according to claim 1, further comprising means for distinguishing between a plurality of users.

11. The system according to claim 1, wherein the controller automatically adapts a program in response to a history of compliance of the user with at least one previous instructional cue to improve compliance of the user with the at least one instructional cue.

12. The system according to claim 1, wherein the controller automatically adapts the at least one instructional cue in response to a history of compliance with at least one previous instructional cue to improve the compliance of the user with the at least one instructional cue.

13. The system according to claim 1, further comprising an interface for loading a new instructional cue into the memory.

14. The system according to claim 1, further comprising a reward effector in communication with the controller and the compliance sensor, wherein the reward effector in response to the controller and the compliance sensor relays a reward.

15. The system according to claim 14, wherein the reward is selected from the group consisting of laudatory messages, physical rewards, visual rewards, audible rewards, music, and combinations thereof.

16. The system according to claim 1, further comprising at least one effector in communication with the controller, wherein the controller communicates the selected instructional cue to the effector and the effector relays the selected instructional cue to the user.

17. The system according to claim 16, wherein the effector dispenses at least one object for collection by the user.

18. The system according to claim 16, further comprising:
a base unit comprising at least the controller; and
at least one remote unit, separate from the base unit and in communication with the base unit, the remote unit comprising a component selected from the group consisting of effectors, compliance sensors, proximity sensors, environmental sensors, user action sensors, object sensors, and combinations thereof.

19. The system according to claim 18, wherein the at least one remote unit comprises at least one effector and a memory for storing the at least one instructional cue.

20. The system according to claim 18, further comprising a wireless communications interface for wireless communications between the base unit and the at least one remote unit.

21. The system according to claim 18, wherein the at least one remote unit comprises a plurality of remote units, each remote unit comprising an identification code for identification by the controller, and wherein the system further comprises a means for associating additional remote units with the base unit.

22. The system according to claim 1, wherein the controller is a remote controller, the system further comprising an interface for communicating with at least one of the remote controller and the memory.

23. A method for providing instructional cues to a user, comprising:
detecting proximity of a user;
detecting compliance of the user with at least one first instructional cue;
selecting at least one second instructional cue from a plurality of instructional cues in response to proximity of the user and compliance of the user with the at least one first instructional cue;
relaying the at least one second instructional cue to the user.

24. The method according to claim 23, further comprising rewarding the user in response to compliance of the user with an instructional cue selected from the group consisting of the at least one first instructional cue and the at least one second instructional cue.

25. The method according to claim 23, further comprising detecting a time, wherein the selecting at least one second instructional cue is in response to proximity of the user, compliance of the user with the first instructional cue, and time.

26. The method according to claim 23, wherein the at least one second instructional cue instructs the user to refrain from performing a task.
